(19) United States
(12) Patent Application Publication
(10) Pub. No.: US 2024/0401392 A1
(43) Pub. Date: Dec. 5, 2024

(54) VEHICLE DOOR APPARATUS

(71) Applicant: AISIN CORPORATION, Kariya (JP)

(72) Inventors: Katsusuke ARAKI, Kariya-shi (JP); Seiichi SUMIYA, Kariya-shi (JP); Akiyoshi MORI, Kariya-shi (JP); Tomoaki FUKATAMI, Fujisawa-shi (JP); Yusuke KAJINO, Kariya-shi (JP); Jueru SHIMIZU, Kariya-shi (JP); Sho KUME, Kariya-shi (JP); Masayoshi YAMAGUCHI, Kariya-shi (JP)

(73) Assignee: AISIN CORPORATION, Kariya (JP)

(21) Appl. No.: 18/692,850

(22) PCT Filed: Oct. 21, 2022
(86) PCT No.: PCT/JP2022/039291

§ 371 Date: Mar. 18, 2024

(30) Foreign Application Priority Data
Nov. 2, 2021 (JP) 2021-179836
Nov. 2, 2021 (JP) 2021-179837
May 17, 2022 (JP) 2022-081026
Sep. 2, 2022 (JP) 2022-139912

(51) Int. Cl. E05F 15/63; E05D 3/14; E05F 1/12

(52) U.S. Cl. CPC E05F 15/63; E05D 3/147; E05F 1/1207; E05Y 2201/638; E05Y 2900/531

(57) ABSTRACT

A vehicle door apparatus includes first and second link arms each having a first pivot coupling point with respect to a vehicle body and a second pivot coupling point with respect to a door of a vehicle. The vehicle door apparatus includes a coupling length variable mechanism provided on at least one of the first and second link arms and configured such that a coupling length serving as a distance between the first and second pivot coupling points is variable. The coupling length variable mechanism is configured to change an opening and closing motion track of the door.

### TECHNICAL FIELD

The present disclosure relates to a vehicle door apparatus.

### BACKGROUND ART

Conventionally, there has been a vehicle door apparatus including first and second link arms each having a first pivot coupling point with respect to a vehicle body and a second pivot coupling point with respect to a door of a vehicle. Such a vehicle door apparatus moves such that the door opens and closes a door opening portion of the vehicle body on the basis of a motion of a link mechanism formed by the first and second link arms. For example, Patent Literature 1 discloses a configuration in which, in a case where the door is in a closed state, first and second link arms forming a link mechanism are retracted in a space between an outer side of a door opening trim attached to a terminal portion of a side portion of a vehicle body, and an inner side of a weather strip attached to a vehicle interior side of the door. For example, Patent Literature 2 discloses a configuration in which a link mechanism formed by such a link arm is combined with a structure in which a guide rail of a vehicle body and a guide roller unit of a door are engaged with each other.

### CITATIONS LIST

### Patent Literature

Patent Literature 1: JP 2006-90097 A
Patent Literature 2: JP 2008-163693 A

### BRIEF SUMMARY

### Technical Problems

In a configuration in which the door is supported on the vehicle body via the link mechanism as described above, an opening and closing motion track of the door is defined on the basis of pivoting of the first and second link arms that constitute the link mechanism. However, if the guide rail is combined as in the conventional techniques described above in order to increase flexibility of the opening and closing motions, a configuration of the vehicle door apparatus is complicated.

### Solutions to Problems

In one aspect of the present disclosure, a vehicle door apparatus includes first and second link arms each having a first pivot coupling point with respect to a vehicle body and a second pivot coupling point with respect to a door of a vehicle, and a coupling length variable mechanism that is provided on at least one of the first and second link arms and is configured such that a coupling length serving as a distance between the first and second pivot coupling points is variable. The first and second link arms form a link mechanism configured to cause the door to perform opening and closing motions along a specified opening and closing motion track. The coupling length variable mechanism is configured to operate to change the opening and closing motion track between an arc-shaped track and a linear-shaped track.

### BRIEF DESCRIPTION OF DRAWINGS

FIG. 1 is a perspective view of a vehicle door apparatus.

FIG. 2 is a perspective view of the vehicle door apparatus.

FIG. 3 is a plan view of first and second link arms forming link mechanisms.

FIG. 4 is a plan view of the first and second link arms forming the link mechanisms.

FIG. 5 is a plan view of the first and second link arms forming the link mechanisms.

FIG. 6 is a plan view of the first and second link arms forming the link mechanisms.

FIG. 7 is a schematic configuration diagram of a door-side engagement portion and a vehicle-body-side engagement portion.

FIG. 8 is an explanatory diagram showing disposition of the door-side engagement portions and the vehicle-body-side engagement portions.

FIG. 9 is a perspective view of a door and a door opening portion, showing disposition of the door-side engagement portions and the vehicle-body-side engagement portions.

FIG. 10 is a perspective view of the door-side engagement portion and the vehicle-body-side engagement portion.

FIG. 11 is a side view of the door-side engagement portion and the vehicle-body-side engagement portion.

FIG. 12 is a cross-sectional view of the door-side engagement portion and the vehicle-body-side engagement portion.

FIG. 13 is a cross-sectional view of the door-side engagement portion and the vehicle-body-side engagement portion.

FIG. 14 is an exploded perspective view of the door-side engagement portion and the vehicle-body-side engagement portion.

FIG. 15 is a front view of the door-side engagement portion.

FIG. 16 is a side view of the door-side engagement portion.

FIG. 17 is a perspective view of a first guide member and a fixing bracket that constitute an upper vehicle-body-side engagement portion.

FIG. 18 is a perspective view of a second guide member and a fixing bracket that constitute a lower vehicle-body-side engagement portion.

FIG. 19 is a side view of the second guide member and the fixing bracket.

FIG. 20 is a cross-sectional view of the second guide member and the fixing bracket.

FIG. 21 is a perspective view of the first guide member and the fixing bracket.

FIG. 22 is a plan view of a joint link mechanism that constitutes a coupling length variable mechanism provided on the second link arm.

FIG. 23 is a plan view of the joint link mechanism.

FIG. 24 is a perspective view of the vehicle door apparatus.

FIG. 25 is a perspective view of the vehicle door apparatus.

FIG. 26 is a plan view of the second link arm having the joint link mechanism.

FIG. 27 is an explanatory diagram of a motion of the second link arm having the joint link mechanism.

FIG. 28 is a side view of the second link arm having the joint link mechanism.

FIG. 29 is an exploded perspective view of the second link arm having the joint link mechanism.

FIG. 30 is a cross-sectional view of the second pivot coupling point of the second link arm and an intermediate coupling point of the joint link mechanism.

FIG. 31 is a plan view of an engagement protrusion provided on the second link arm and a cam member provided on the door.

FIG. 32 is a plan view of the engagement protrusion provided on the second link arm and the cam member provided on the door.

FIG. 33 is a plan view of the engagement protrusion provided on the second link arm and the cam member provided on the door.

FIG. 34 is a plan view of the engagement protrusion provided on the second link arm and the cam member provided on the door.

FIG. 35 is a perspective view of a vicinity of the first pivot coupling point of the second link arm.

FIG. 36 is a cross-sectional view of the first pivot coupling point of the second link arm.

FIG. 37 is a perspective view of the first link arm and an actuator.

FIG. 38 is an exploded perspective view of the first link arm and the actuator.

FIG. 39 is a side view of the first link arm.

FIG. 40 is a cross-sectional view of a tip end bracket, a door bracket, and a friction member that constitute the second pivot coupling point of the first link arm.

FIG. 41 is a side view of a vicinity of a first pivot coupling point of the first link arm.

FIG. 42 is a plan view of an extensible link mechanism that constitutes a coupling length variable mechanism, according to another example.

FIG. 43 is a plan view of the extensible link mechanism.

FIG. 44 is a plan view of a coupling length fixing mechanism according to a second embodiment.

FIG. 45 is a plan view of the coupling length fixing mechanism according to the second embodiment.

FIG. 46 is a plan view of the coupling length fixing mechanism according to the second embodiment.

FIG. 47 is a timing chart describing engagement and disengagement timings of the respective coupling length fixing mechanism and a guide mechanism.

FIG. 48 is a plan view of a coupling length fixing mechanism according to a third embodiment.

FIG. 49 is a plan view of the coupling length fixing mechanism according to the third embodiment.

FIG. 50 is a plan view of the coupling length fixing mechanism according to the third embodiment.

FIG. 51 is a side view of a timing generation unit that constitutes the coupling length fixing mechanism, according to the third embodiment.

FIG. 52 is a side view of the timing generation unit that constitutes the coupling length fixing mechanism, according to the third embodiment.

FIG. 53 is a side view of the timing generation unit that constitutes the coupling length fixing mechanism, according to the third embodiment.

FIG. 54 is a block diagram showing a schematic configuration of a coupling length fixing mechanism according to another example.

FIG. 55 is a side view of a door bracket and a second link arm according to a fourth embodiment.

FIG. 56 is an exploded perspective view of the door bracket and the second link arm according to the fourth embodiment.

FIG. 57 is a plan view of the door bracket and the second link arm according to the fourth embodiment.

FIG. 58 is a plan view of the door bracket and the second link arm according to the fourth embodiment.

FIG. 59 is a plan view of the door bracket and the second link arm according to the fourth embodiment.

FIG. 60 is a plan view showing a shape of a cam groove according to the fourth embodiment.

FIG. 61 is a plan view of the door bracket and the second link arm according to the fourth embodiment.

### DESCRIPTION OF EMBODIMENTS

### First Embodiment

Hereinafter, a first embodiment of a vehicle door apparatus will be described with reference to the drawings. In the following description, terms such as front, rear, up, down, left, and right are defined with reference to a vehicle 1.

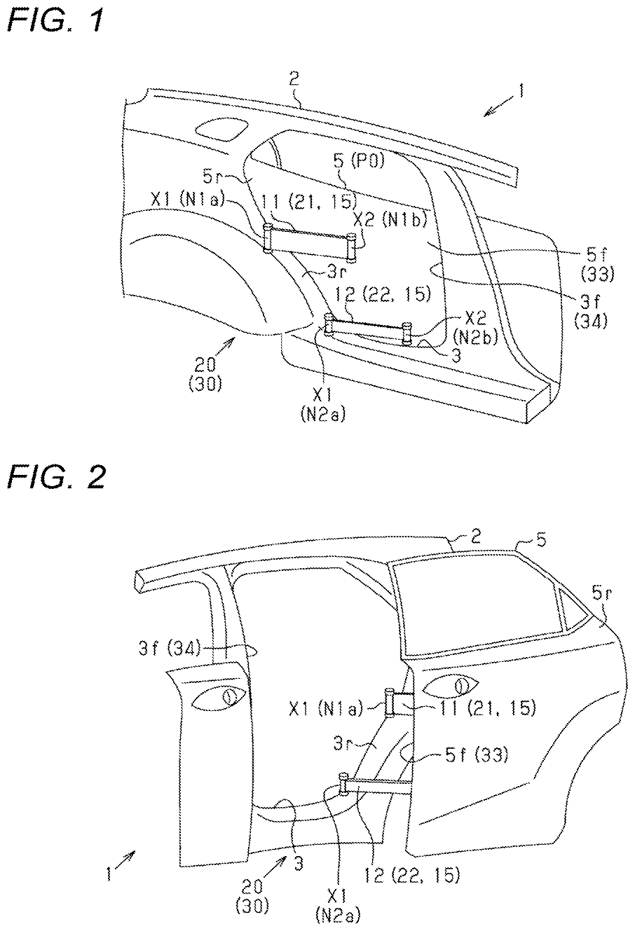

As shown in FIGS. 1 and 2, the vehicle 1 of the present embodiment includes a door opening portion 3 provided on a side surface of a vehicle body 2. The door opening portion 3 is provided with a first link arm 11 and a second link arm 12 that support a door 5 that opens and closes the door opening portion 3. The door 5 is, for example, a rear door.

Specifically, in the vehicle 1 of the present embodiment, the first and second link arms 11, 12 each have a first pivot coupling point X1 with respect to the vehicle body 2 and a second pivot coupling point X2 with respect to the door 5. The first link arm 11 is pivotably coupled to the vehicle body 2 about a pivot axis N1a extending in an up-down direction, and is pivotably coupled to the door 5 about a pivot axis N1b extending in the up-down direction. The second link arm 12 is also pivotably coupled to the vehicle body 2 about a pivot axis N2a extending in the up-down direction, and is also pivotably coupled to the door 5 about a pivot axis N2b extending in the up-down direction.

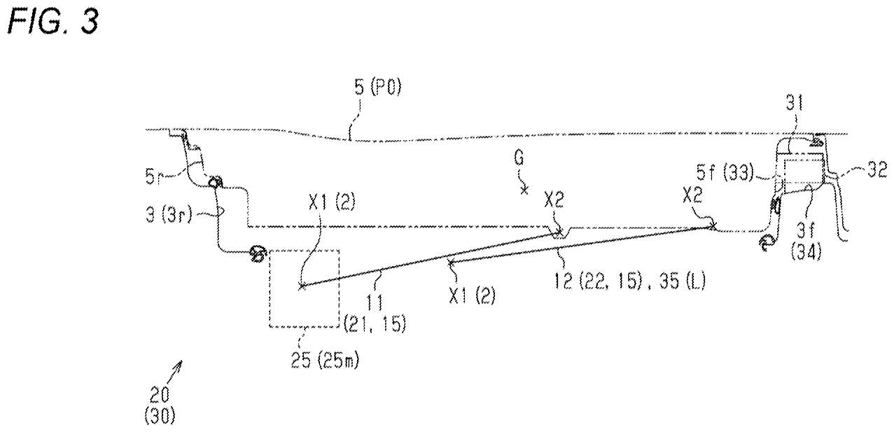

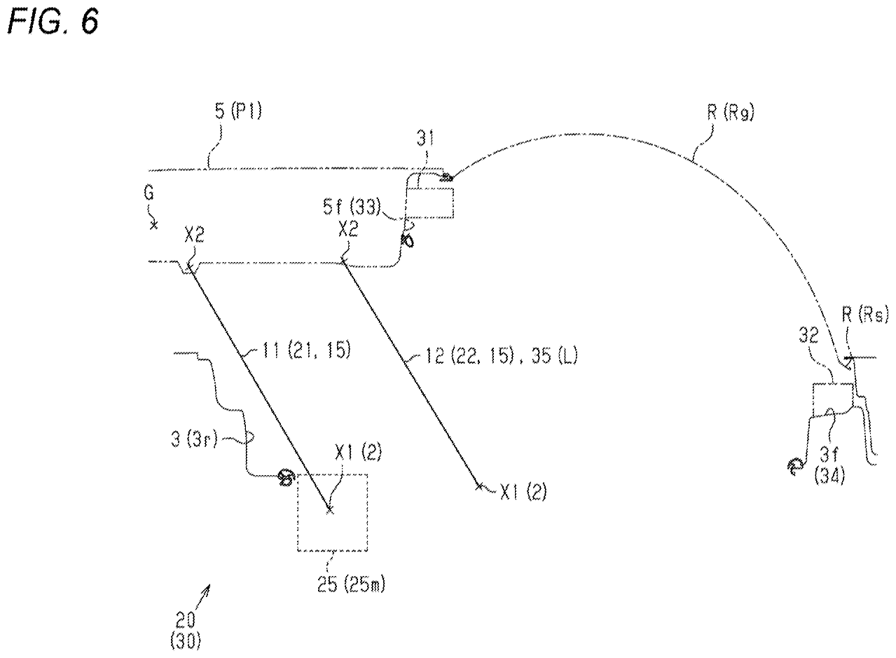

As shown in FIGS. 3 to 6, in the vehicle 1 of the present embodiment, the first and second link arms 11, 12 form a link mechanism 15 that is a four-bar link. The door 5 moves to open and close the door opening portion 3 on the basis of a motion of the link mechanism 15.

More specifically, as shown in FIGS. 1 and 2, each of the first and second link arms 11, 12 has the first pivot coupling point X1 pivotably coupled to the vehicle body 2 in a vicinity of a rear edge portion 3r of the door opening portion 3. The first and second link arms 11, 12 are disposed to be separated from each other in the up-down direction.

The first link arm 11 is provided above the second link arm 12. Furthermore, the first link arm 11 has the second pivot coupling point X2 pivotably coupled to the door 5 at a substantially central position in a front-rear direction of the door 5. Meanwhile, the second link arm 12 has the second pivot coupling point X2 coupled to the door 5 in the vicinity of a front end portion 5f of the door 5. The vehicle 1 of the present embodiment includes a vehicle door apparatus 20 that causes the door 5 to perform opening and closing motions on the basis of the motion of the link mechanism 15 formed by the first and second link arms 11, 12.

As shown in FIGS. 3 to 6, in the vehicle door apparatus 20 of the present embodiment, the respective first and second link arms 11, 12 pivot counterclockwise about the first pivot coupling point X1 during an opening motion of the door 5. Thus, the door 5 supported by the first and second link arms 11, 12 performs the opening motion toward a rear side (left side in each drawing).

Furthermore, in the vehicle door apparatus 20 of the present embodiment, the respective first and second link arms 11, 12 pivot clockwise about the first pivot coupling point X1 during a closing motion of the door 5. Thus, the door 5 supported by the first and second link arms 11, 12 performs the closing motion toward a front side (right side in each drawing).

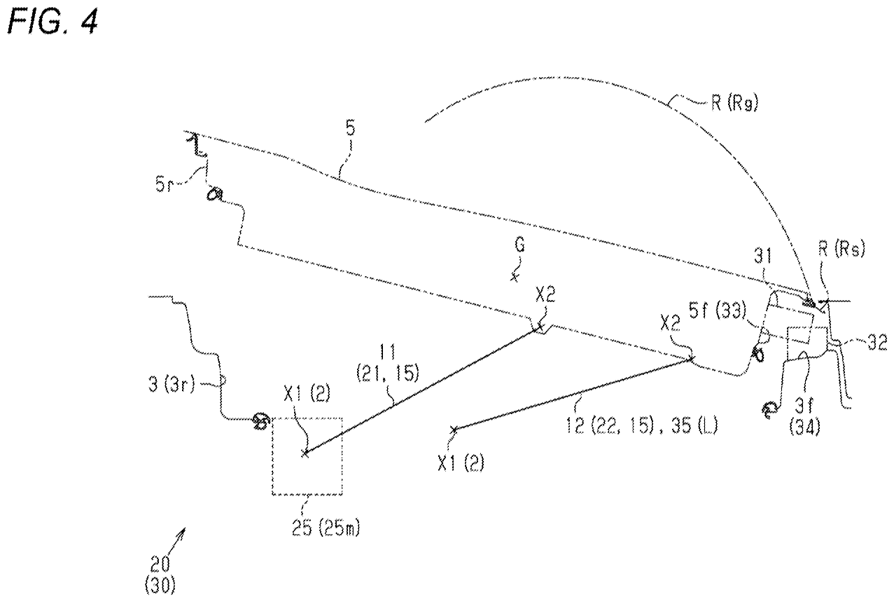

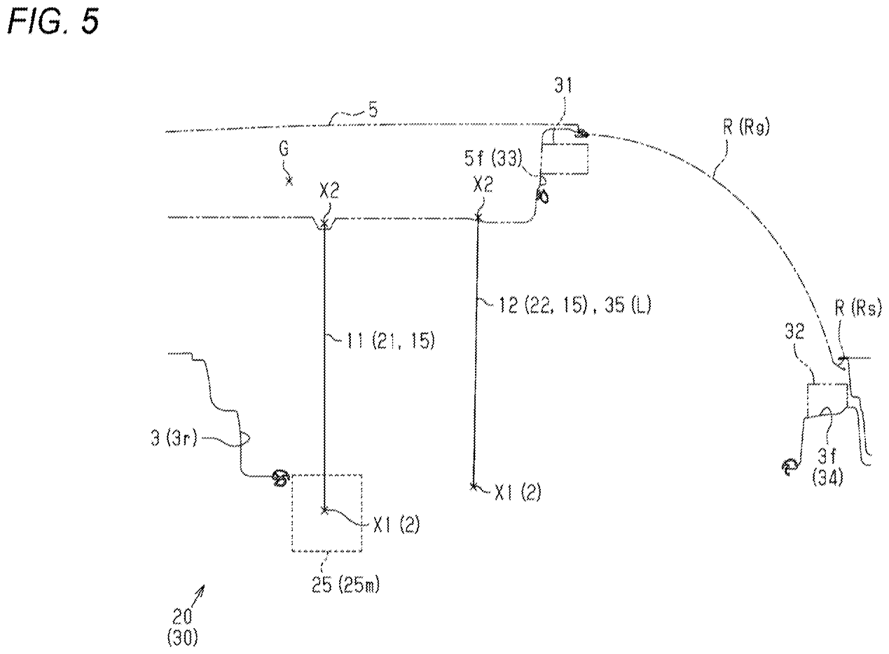

In the vehicle door apparatus 20 of the present embodiment, the opening and closing motion track (movement track) R of the door 5 is defined so as to draw an arc-shaped glide track Rg, on the basis of the motion of the link mechanism 15 formed by the first and second link arms 11, 12. That is, as shown in FIG. 5, in a state where the door 5 is at an intermediate position of the opening and closing motion track R, the first and second link arms 11, 12 extend in a vehicle width direction (up-down direction in FIGS. 3 to 6). In this state, of components of the door 5 in a movement direction, a component in the front-rear direction increases. As shown in FIGS. 3 and 4, the closer a position of the door 5 is to a fully closed position P0, the closer the first and second link arms 11, 12 extend closer in the front-rear direction (left-right direction in FIGS. 3 to 6) from the vehicle width direction. Accordingly, of components of the door 5 in the movement direction, a component in the vehicle width direction increases.

Furthermore, in the vehicle door apparatus 20 of the present embodiment, the first link arm 11 has the second pivot coupling point X2 thereof at a position closer to a center of gravity G of the door 5 than the second link arm 12 does. Thus, the first link arm 11 is positioned as a main link 21 that supports larger door load. The second link arm 12 is positioned as a sub link 22 on which door load acts relatively small.

The first link arm 11 has a larger outer shape than the second link arm 12 does. Thus, high support stiffness is imparted to the first link arm 11 positioned as the main link 21.

Furthermore, the vehicle door apparatus 20 of the present embodiment includes an actuator 25 that rotationally drives the first link arm 11. The actuator 25 includes a motor 25m as a drive source. The actuator 25 is provided on a base end portion of the first link arm 11. By causing the first link arm 11 to pivot, the actuator 25 drives the link mechanism 15 formed by the first link arm 11 and the second link arm 12. The vehicle door apparatus 20 has a configuration as a power-door apparatus 30 that can cause, on the basis of a drive force of the actuator 25, the door 5 to perform opening and closing motions.

Furthermore, as shown in FIGS. 3 to 7, the vehicle door apparatus 20 of the present embodiment includes a door-side engagement portion 31 provided on the front end portion 5f of the door 5 and a vehicle-body-side engagement portion 32 provided on a front edge portion 3f of the door opening portion 3. The door-side engagement portion 31 is provided on a closing-side end portion 33 that is an end portion on a preceding side in the closing motion of the door 5. The vehicle-body-side engagement portion 32 is provided on a closing-side end portion 34 where the closing-side end portion 33 of the door 5 approaches or leaves, the closing-side end portion 34 being a portion of the door opening portion 3. In a state where the door 5 is in a vicinity of the fully closed position P0, the door-side engagement portion 31 and the vehicle-body-side engagement portion 32 are engaged with each other.

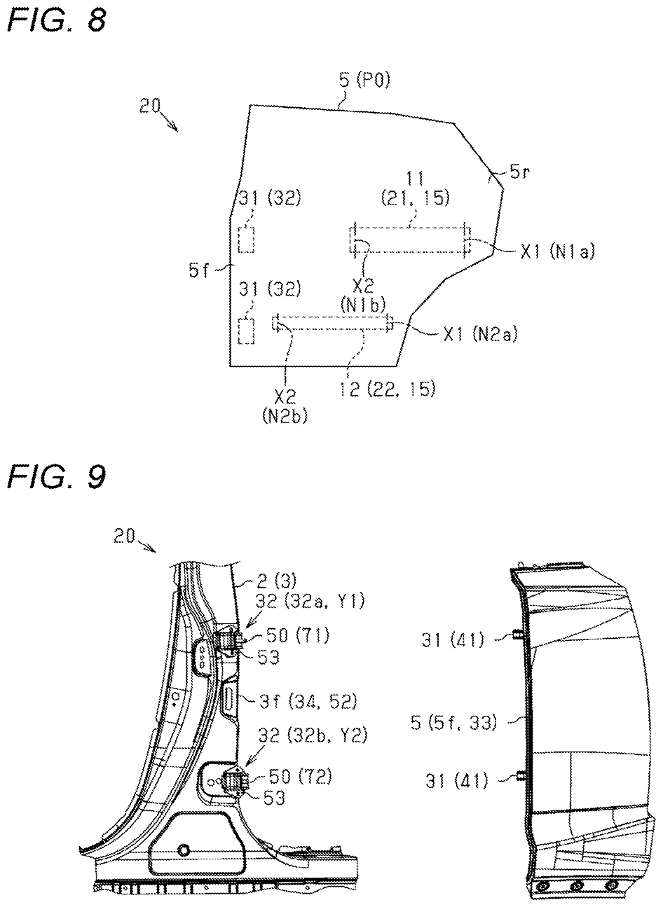

Specifically, as shown in FIGS. 8 and 9, the vehicle door apparatus 20 of the present embodiment includes the door-side engagement portions 31, 31 provided on the front end portion 5f of the door 5 at two positions separated from each other in the up-down direction. The vehicle door apparatus 20 includes vehicle-body-side engagement portions 32, 32 provided on the front edge portion 3f of the door opening portion 3, similarly at two positions separated from each other in the up-down direction. The vehicle door apparatus 20 holds the door 5 at the fully closed position P0 in a state where the door-side engagement portions 31, 31 and the vehicle-body-side engagement portions 32, 32 are engaged with each other.

Furthermore, as shown in FIGS. 3 to 6, the second link arm 12 positioned as the sub link 22 is provided with a coupling length variable mechanism 35 in which a coupling length L serving as a distance between the first and second pivot coupling points X1, X2 is variable. The coupling length variable mechanism 35 is biased in a distance between the first and second pivot coupling points X1, X2, that is, a direction in which the coupling length L between the vehicle body 2 and the door 5 by the second link arm 12 is shortened. Thus, the door 5 performs opening and closing motions in a state where the coupling length L is shortened.

As shown in FIGS. 3, 4, and 7, in the vehicle door apparatus 20 of the present embodiment, there are allowed the opening and closing motions of the door 5 on the basis of operation of the coupling length variable mechanism 35, in a state where the door-side engagement portion 31 and the vehicle-body-side engagement portion 32 are engaged with each other. That is, in the vicinity of the fully closed position P0 where the door-side engagement portion 31 and the vehicle-body-side engagement portion 32 are engaged with each other, a posture of the door 5 supported by the link mechanism 15 changes by the coupling length L between the vehicle body 2 and the door 5 changing. Thus, the door 5 performs the opening and closing motions in such a manner that the front end portion 5f of the door 5 provided with the door-side engagement portion 31 moves in the front-rear direction and a rear end portion 5r of the door 5 moves in the vehicle width direction.

Specifically, for example, during the closing motions of the door 5 toward the fully closed position P0, the door 5 is in an inclined posture in which the rear end portion 5r is positioned more outward in the vehicle width direction (upper side in each drawing) than the front end portion 5f. At this time, in a state where the door-side engagement portion 31 and the vehicle-body-side engagement portion 32 are engaged with each other, the drive force of the actuator 25 or manual operation force is applied to the door 5 in a closing motion direction. The coupling length variable mechanism 35 operates on the basis of force that causes the door 5 to perform a closing motion, by which the coupling length L between the vehicle body 2 and the door 5 is extended on the basis of the state of engagement between the door-side engagement portion 31 and the vehicle-body-side engagement portion 32. Thus, the door 5 supported by the link mechanism 15 performs a full closing motion in such a manner that the front end portion 5f draws a linear-shaped slide track Rs along with movement of the rear end portion 5r inward in the vehicle width direction.

Furthermore, at a time of an opening motion from the state where the door 5 is at the fully closed position P0, in a state where the door-side engagement portion 31 and the vehicle-body-side engagement portion 32 are engaged with each other, the drive force of the actuator 25 or manual operation force is applied to the door 5 in an opening motion direction. The coupling length variable mechanism 35 operates on the basis of force that causes the door 5 to perform an opening motion, by which the coupling length L between the vehicle body 2 and the door 5 is shortened on the basis of the state of engagement between the door-side engagement portion 31 and the vehicle-body-side engagement portion 32. Thus, the door 5 supported by the link mechanism 15 performs an opening motion in such a manner that the front end portion 5f draws a linear-shaped slide track Rs along with movement of the rear end portion 5r outward in the vehicle width direction.

### (Door-Side Engagement Portion and Vehicle-Body-Side Engagement Portion)

Next, configurations of the door-side engagement portion 31 and the vehicle-body-side engagement portion 32 will be described.

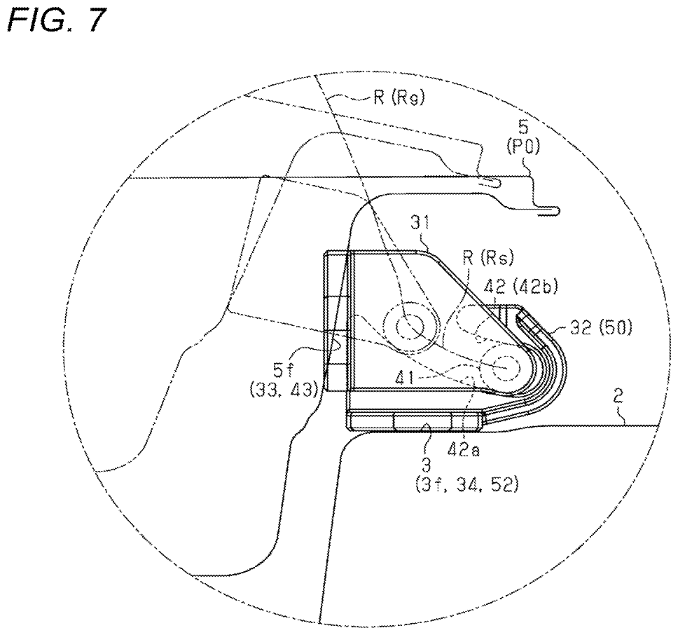

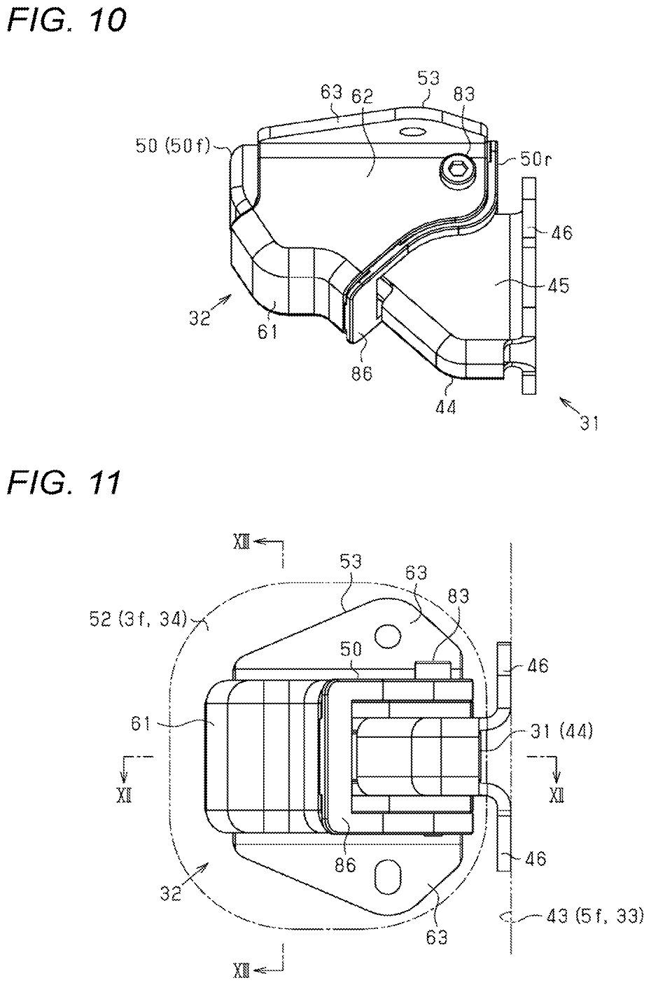

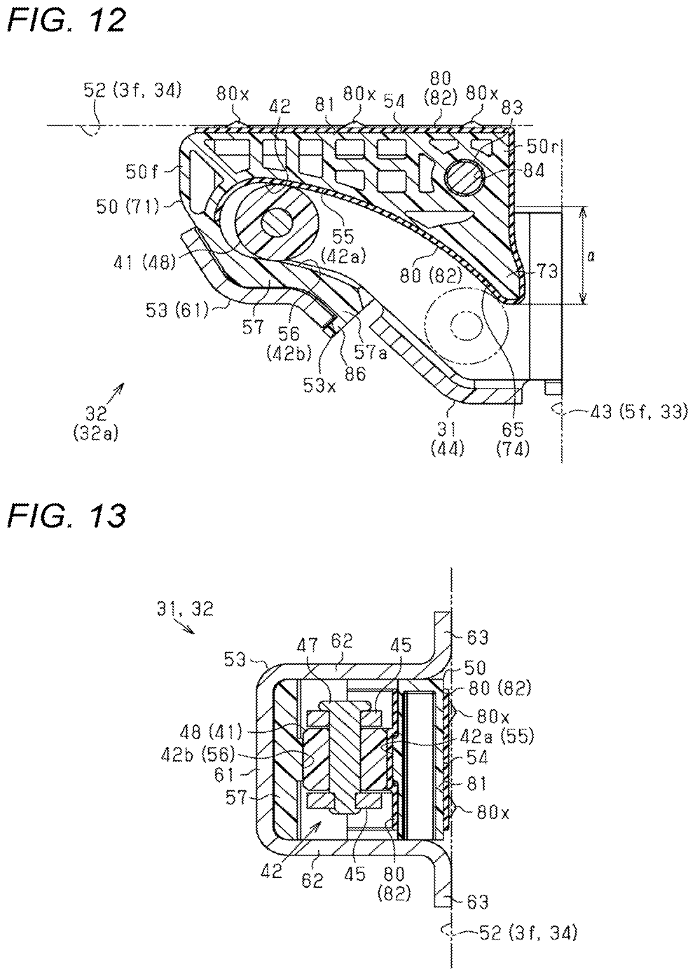

As shown in FIGS. 7 and 9 to 14, the door-side engagement portion 31 includes a shaft-shaped engagement portion 41 that is a guide engagement portion extending in the up-down direction (direction orthogonal to paper surface in FIGS. 7 and 12, and up-down direction in FIGS. 11 and 13). Furthermore, the vehicle-body-side engagement portion 32 includes a guide groove 42 having a pair of side wall portions 42a, 42b facing each other in the vehicle width direction (up-down direction in FIGS. 7 and 12, and left-right direction in FIG. 13), the guide groove 42 extending in the opening and closing motion directions of the door 5. In a case where the door 5 is in the vicinity of the fully closed position P0, the door-side engagement portion 31 and the vehicle-body-side engagement portion 32 are engaged with each other in a state where the shaft-shaped engagement portion 41 is disposed in the guide groove 42.

As shown in FIGS. 7 and 12, the shaft-shaped engagement portion 41 of the door-side engagement portion 31 is disposed in the guide groove 42 of the vehicle-body-side engagement portion 32 while being sandwiched between the pair of side wall portions 42a, 42b, by which displacement of the door 5 in the vehicle width direction is restricted. Thus, the door 5 can be stably supported also in the vicinity of the fully closed position P0 where the first and second link arms 11, 12 are likely to be aligned (refer to FIGS. 3 and 4).

Moreover, when the door 5 performs opening and closing motions in this state, the shaft-shaped engagement portion 41 is relatively displaced apparently along an extending direction of the guide groove 42, along with a change in the coupling length L based on the operation of the coupling length variable mechanism 35. Thus, the opening and closing motion track R of the door 5 changes, that is, the arc-shaped glide track Rg based on the motion of the link mechanism 15 changes to the linear-shaped slide track Rs.

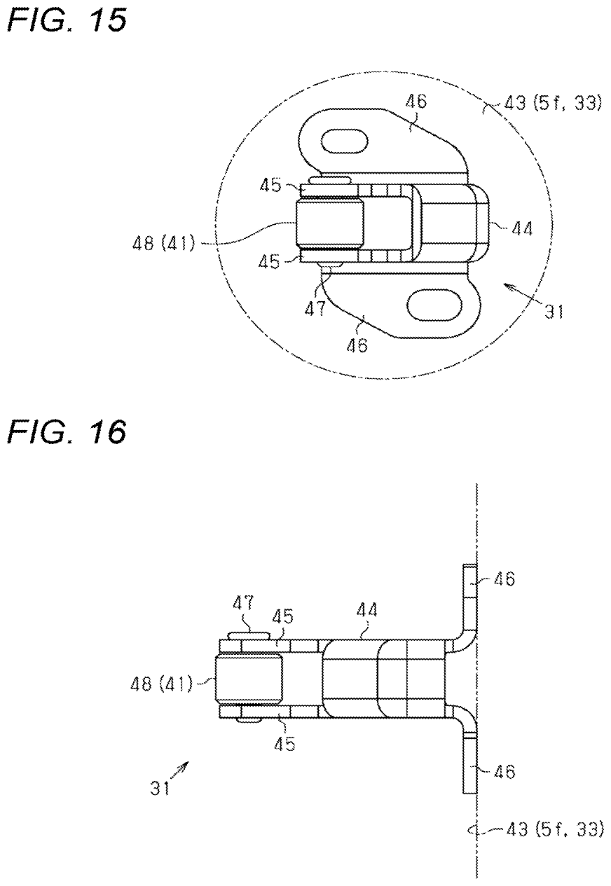

As shown in FIGS. 10 to 16, the door-side engagement portion 31 of the present embodiment includes a support bracket 44 fixed to an installation surface 43 (refer to FIG. 7) set at the closing-side end portion 33 of the door 5. The support bracket 44 includes a pair of support walls 45, 45 facing each other in the up-down direction (up-down direction in FIGS. 15 and 16), and a pair of flange portions 46, 46 provided on base end portions of the support walls 45, 45. Both the support walls 45, 45 and both the flange portions 46, 46 are integrally formed by bending a metal plate material. Furthermore, the installation surface 43 of the door 5 to which the support bracket 44 is fixed is set at the front end portion 5f of the door 5 so as to face a direction in which the door 5 performs the closing motion. The pair of flange portions 46, 46 is fastened to the installation surface 43 of the door 5.

The door-side engagement portion 31 includes a support shaft 47 bridged between the pair of support walls 45, 45 of the support bracket 44. The support shaft 47 is provided on tip end portions of the support walls 45, 45 protruding toward the front side from the installation surface 43 of the door 5. The door-side engagement portion 31 includes a roller 48 rotatably supported by the support shaft 47. The roller 48 functions as the shaft-shaped engagement portion 41 of the door-side engagement portion 31.

Meanwhile, as shown in FIGS. 10 to 14, the vehicle-body-side engagement portion 32 includes a guide member 50 forming the guide groove 42. The vehicle-body-side engagement portion 32 includes a fixing bracket 53 that fixes the guide member 50 to an installation surface 52 set at the closing-side end portion 34 of the door opening portion 3.

The guide member 50 and the fixing bracket 53 are fixed to the installation surface 52 of the vehicle body 2, and the installation surface 52 is set on the front edge portion 3f of the door opening portion 3 so as to face outward in the vehicle width direction (lower side in FIG. 12, left side in FIG. 13). The fixing bracket 53 fixes the guide member 50 while sandwiching a portion of the guide member 50 forming the guide groove 42 with the installation surface 52 of the vehicle body 2.

Specifically, the guide member 50 of the present embodiment has a fixing surface 54 fixed to the installation surface 52 of the vehicle body 2, and a first facing surface 55 facing outward in the vehicle width direction in a state where the guide member 50 is fixed to the installation surface 52. That is, the fixing surface 54 and the first facing surface 55 face directions opposite to each other. Moreover, the guide member 50 includes an engagement piece 57 having a second facing surface 56 facing the first facing surface 55. The first facing surface 55 and the second facing surface 56 are a pair of side wall portions 42a, 42b facing each other in the vehicle width direction, and form the guide groove 42.

The engagement piece 57 has a substantially plate-like outer shape protruding rearward (right side in FIG. 12) from a front end portion 50f of the guide member 50 in a state where the guide member 50 is fixed to the installation surface 52. Thus, the guide groove 42 opening in the up-down direction and rearward is formed.

The fixing bracket 53 has an outer shape that covers the front end portion 50f of the guide member 50 forming the guide groove 42. Specifically, the fixing bracket 53 includes a restriction wall 61 that abuts, from an outer side in the vehicle width direction, on the above-described engagement piece 57 provided on the front end portion 50f of the guide member 50. Moreover, the fixing bracket 53 includes a pair of side wall portions 62, 62 that is continuous with the restriction wall 61 and covers the guide member 50 from the up-down direction. The fixing bracket 53 includes a pair of flange portions 63, 63 provided on base end portions of the side wall portions 62, 62.

The fixing bracket 53 of the present embodiment is formed by bending a metal plate material. The restriction wall 61, both the side wall portions 62, 62, and both the flange portions 63, 63 are a single integral body. The pair of flange portions 63, 63 is fastened to the installation surface 52 of the vehicle body 2. The front end portion 50f of the guide member 50 including the engagement piece 57 described above, that is, a portion forming the guide groove 42 is sandwiched between the restriction wall 61 and the installation surface 52 of the vehicle body 2.

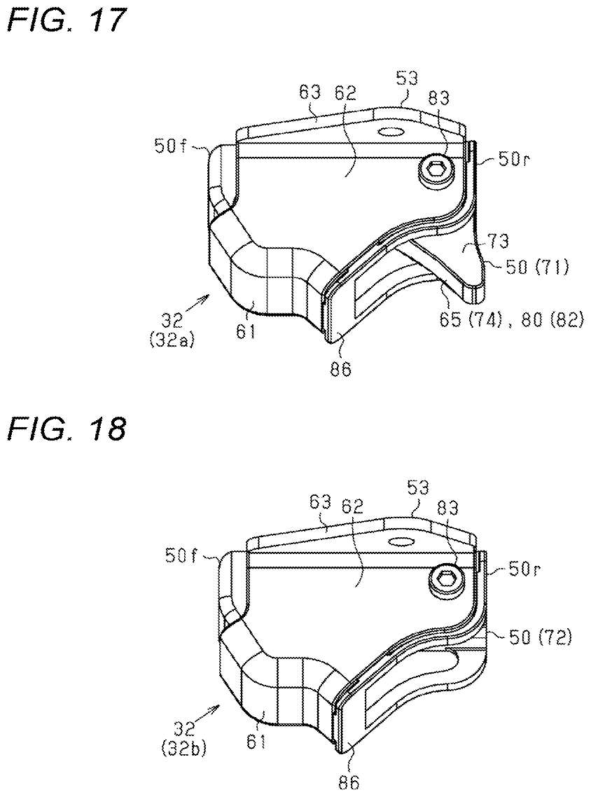

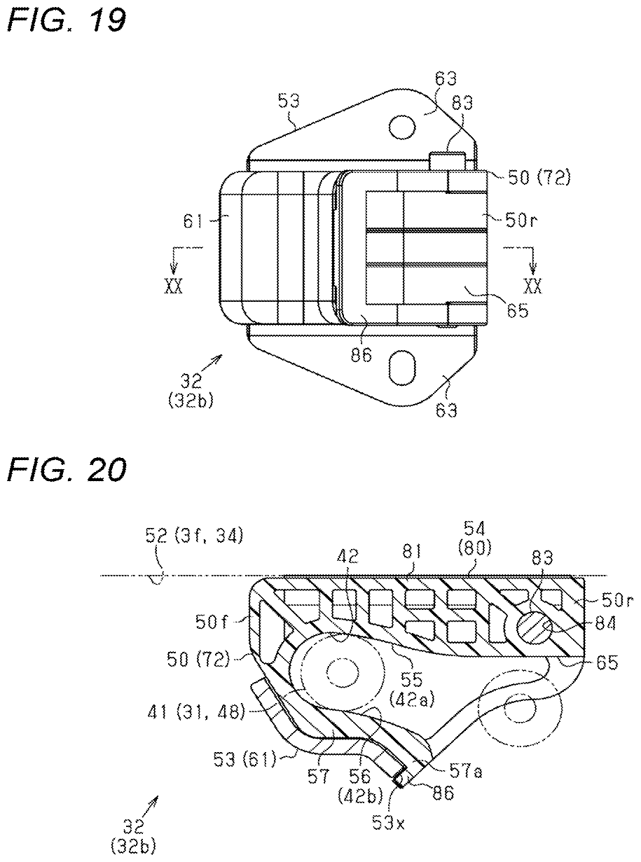

Furthermore, as shown in FIGS. 9 to 14, 17, and 18 to 20, in the vehicle door apparatus 20 of the present embodiment, there is a difference in shape of the two guide members 50 that constitute the two vehicle-body-side engagement portions 32, 32 provided to be separated from each other in the up-down direction.

Specifically, each guide member 50 includes a guide surface 65 continuous with the guide groove 42. The guide surface 65 is provided on a rear end portion 50r of the guide member 50. The guide surface 65 faces outward in the vehicle width direction and is continuous with the above-described first facing surface 55 of the guide member 50, that is, the guide surface 65 is continuous with one side wall portion 42a that constitutes the guide groove 42. The shaft-shaped engagement portion 41 that is engaged with and disengaged from the guide groove 42 of the guide member 50 on the basis of the opening and closing motions of the door 5 abuts on the guide surface 65, thereby being guided in a direction of entering the guide groove 42 and a direction of being detached from the guide groove 42. In the present embodiment, portions forming the guide surface 65 have a difference in shape between a first guide member 71 that constitutes an upper vehicle-body-side engagement portion 32a and a second guide member 72 that constitutes a lower vehicle-body-side engagement portion 32b.

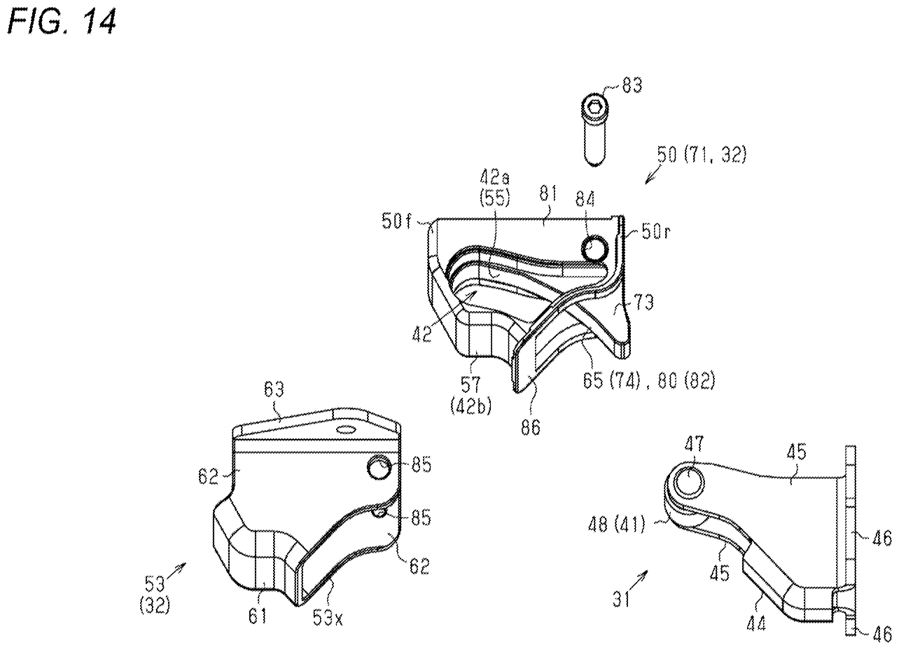

As shown in FIGS. 12 and 14, the first guide member 71 is provided with a guide protrusion 73 protruding outward in the vehicle width direction in a state where the first guide member 71 is fixed to the installation surface 52. The guide protrusion 73 protrudes in a direction in which the shaft-shaped engagement portion 41 comes into contact and separates on the basis of the opening and closing motions of the door 5. The guide protrusion 73 has a substantially triangular plate-like outer shape such that a protrusion amount a gradually increases from the front end portion 50f of the guide member 50 toward the rear end portion 50r of the guide member 50. A tilted surface 74 formed by the guide protrusion 73 and facing outward in the vehicle width direction forms the guide surface 65 of the first guide member 71.

By using the tilted surface 74 as the guide surface 65 of the guide member 50, an abutting angle of the shaft-shaped engagement portion 41 with respect to the guide surface 65 decreases when the shaft-shaped engagement portion 41 of the door-side engagement portion 31 abuts on the guide surface 65. Thus, an impact generated when the shaft-shaped engagement portion 41 abuts is mitigated.

The tilted surface 74 of the guide protrusion 73 forming the guide surface 65 is a curved surface having a substantially constant curvature so as to be less tilted toward the guide groove 42. Thus, for example, even in a case where an abutting position of the shaft-shaped engagement portion 41 with respect to the first guide member 71 is displaced during the closing motion of the door 5 due to a tolerance or the like, it is possible to suitably mitigate an impact generated by the abutting.

Meanwhile, as shown in FIGS. 18 to 20, the second guide member 72 that constitutes the lower vehicle-body-side engagement portion 32b is not provided with the guide protrusion 73 as described above. The second guide member 72 has a guide surface 65 that is substantially flat.

The vehicle door apparatus 20 of the present embodiment openably and closably supports the door 5 with the link mechanism 15 formed by the first and second link arms 11, 12. Therefore, in the vicinity of the fully closed position P0 where the first and second link arms 11, 12 come close to each other and are linearly aligned, the posture of the door 5 is likely to change. This may cause a difference in engagement and disengagement postures of the shaft-shaped engagement portion 41 with respect to the guide groove 42, between the upper vehicle-body-side engagement portion 32a and the vehicle-body-side engagement portion 32b.

In particular, as shown in FIGS. 8 and 9, in the vehicle door apparatus 20 of the present embodiment, the upper vehicle-body-side engagement portion 32a is provided on a first up-down direction position Y1 corresponding to the first link arm 11 positioned as the main link 21. Furthermore, the lower vehicle-body-side engagement portion 32b is provided on a second up-down direction position Y2 corresponding to the second link arm 12 positioned as the sub link 22. Thus, the above-described difference in engagement and disengagement postures tends to be noticeable.

Specifically, the first up-down direction position Y1 corresponding to the first link arm 11 is set at an up-down direction position closer to a position at which the first link arm 11 supports the door 5 than a position at which the second link arm 12 supports the door 5. Then, the second up-down direction position Y2 corresponding to the second link arm 12 is set at an up-down direction position closer to the position at which the second link arm 12 supports the door 5 than the position at which the first link arm 11 supports the door 5.

The first link arm 11 has the second pivot coupling point X2 with respect to the door 5 at a position closer to the center of gravity G of the door 5 than the second link arm 12. Moreover, the second link arm 12 is provided with the coupling length variable mechanism 35 in which the coupling length L between the first and second pivot coupling points X1, X2 is variable. Therefore, a change in the posture of the door 5 is greater toward a lower side of the door 5 supported by the second link arm 12. Thus, the engagement and disengagement postures of the shaft-shaped engagement portion 41 with respect to the guide groove 42 are more likely to change with the lower vehicle-body-side engagement portion 32b than with the upper vehicle-body-side engagement portion 32a.

Based on this point, in the vehicle door apparatus 20 of the present embodiment, for the first guide member 71 that constitutes the upper vehicle-body-side engagement portion 32a, an engagement and disengagement track of the shaft-shaped engagement portion 41 with respect to the first guide member 71 is defined by the guide surface 65 formed by the guide protrusion 73 described above. Meanwhile, the second guide member 72 that constitutes the lower vehicle-body-side engagement portion 32b is not provided with such a guide protrusion 73, and thus the shaft-shaped engagement portion 41 has high flexibility of engagement and disengagement of the second guide member 72. Thus, when the shaft-shaped engagement portions 41, 41 are engaged with and disengaged from the corresponding first and second guide members 71, 72, the shaft-shaped engagement portions 41, 41 are less likely to be caught by the corresponding first and second guide members 71, 72.

Note that, such an event in which the first and second guide members 71, 72 and the shaft-shaped engagement portions 41, 41, which are provided to be separated from each other in the up-down direction, are caught is likely to occur, for example, in a case where the door 5 is caused to perform the opening motion from the fully closed position P0, and this may shake the door 5. However, in the vehicle door apparatus 20 of the present embodiment, shaking of the door 5 due to occurrence of such catching is reduced. Thus, excellent feeling of operating the door 5 is ensured.

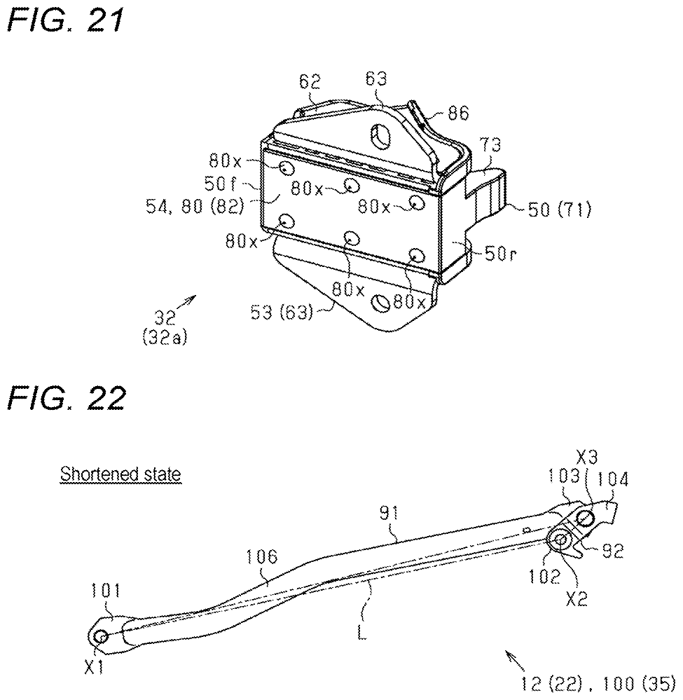

Furthermore, as shown in FIGS. 12, 14, 17, and 21, the first guide member 71 includes a buffer member 80 that has elasticity and mitigates an impact generated when the shaft-shaped engagement portion 41 abuts on the first guide member 71.

Specifically, the buffer member 80 is provided on the guide surface 65 formed by the guide protrusion 73 and on the first facing surface 55 that constitutes the side wall portion 42a of the guide groove 42. That is, in the first guide member 71, the buffer member 80 is provided on a portion on which the shaft-shaped engagement portion 41 of the door-side engagement portion 31 abuts. Furthermore, the buffer member 80 is provided on the fixing surface 54 fixed to the installation surface 52 of the vehicle body 2. That is, the buffer member 80 and the installation surface 52 face each other in a direction in which the shaft-shaped engagement portion 41 of the door-side engagement portion 31 comes into contact with and separates from the first guide member 71. The buffer member 80 has a plurality of protrusions 80x that abut on the installation surface 52 of the vehicle body 2. The first guide member 71 is fixed to the installation surface 52 of the vehicle body 2 in a state where these protrusions 80x are crushed.

The first guide member 71 includes a base member 81 having the guide groove 42 and a covering body 82 covering the base member 81. The covering body 82 functions as the buffer member 80.

For example, a relatively hard material such as fiber-reinforced plastic is used for the base member 81. Furthermore, for example, an elastic material such as rubber or elastomer is used for the covering body 82. For example, the base member 81 and the covering body 82 that constitutes the buffer member 80 are integrally formed by insert molding.

Furthermore, as shown in FIGS. 12, 14, and 17 to 20, the vehicle door apparatus 20 of the present embodiment includes a coupling shaft 83 inserted into the guide member 50 and the fixing bracket 53. Specifically, an insertion hole 84 extending in the up-down direction is provided in the rear end portion 50r of the guide member 50 in a state where the guide member 50 is fixed to the installation surface 52 of the vehicle body 2. Furthermore, each of the side wall portions 62, 62 of the fixing bracket 53 has through holes 85, 85 provided in positions corresponding to the insertion hole 84. The coupling shaft 83 is inserted into the insertion hole 84 and the through holes 85, 85 to couple the guide member 50 and the fixing bracket 53 to each other in a state where the coupling shaft 83 penetrates the guide member 50 and the fixing bracket 53 in the up-down direction.

As shown in FIGS. 12 and 20, the coupling shaft 83 is inserted into the guide member 50 and the fixing bracket 53 while being parallel to the installation surface 52 of the vehicle body 2 and the restriction wall 61 of the fixing bracket 53. The coupling shaft 83 extends in a direction intersecting the front-rear direction in which the guide groove 42 extends.

When the shaft-shaped engagement portion 41 of the door-side engagement portion 31 abuts on the guide member 50, the coupling shaft 83 defines a displacement direction of the guide member 50. Specifically, when the shaft-shaped engagement portion 41 abuts on the guide member 50, the guide member 50 receives a force in a direction of pivoting about the coupling shaft 83. The motion of the guide member 50 due to the force is restricted by the installation surface 52 of the vehicle body 2 or the restriction wall 61 of the fixing bracket 53.

For example, in a case where the shaft-shaped engagement portion 41 that starts to be engaged with the guide groove 42 abuts on the guide member 50 on the basis of the closing motion of the door 5, the guide member 50 receives a force in a direction of pivoting about the coupling shaft 83 (clockwise in each drawing). In this case, displacement of the guide member 50 is restricted by the front end portion 50f of the guide member 50 abutting on the installation surface 52.

Meanwhile, in a case where the shaft-shaped engagement portion 41 that starts to be disengaged from the guide groove 42 abuts on the guide member 50 on the basis of the opening motion of the door 5, the guide member 50 receives a force in a direction of pivoting about the coupling shaft 83 (counterclockwise in each drawing). In this case, the displacement of the guide member 50 is restricted by the front end portion 50f of the guide member 50 abutting on the restriction wall 61 of the fixing bracket 53.

Furthermore, as shown in FIGS. 12, 14, and 17 to 20, the guide member 50 of the present embodiment includes a frame-shaped portion 86 disposed at an inlet of the guide groove 42. The frame-shaped portion 86 has a substantially quadrangular frame-shaped outer shape opening rearward. The frame-shaped portion 86 connects a tip end 57a of the engagement piece 57 described above and the rear end portion 50r of the guide member 50. The shaft-shaped engagement portion 41 enters the guide groove 42 through the frame-shaped portion 86, which is an inlet.

The frame-shaped portion 86 covers a rear end surface 53x of the fixing bracket 53, specifically, the restriction wall 61 and rear end portions of both the side wall portions 62, 62. Thus, the rear end surface 53x of the fixing bracket 53 is protected so as not to come into contact with, for example, a user or the like.

### (Second Link Arm and Coupling Length Variable Mechanism)

Next, configurations of the second link arm 12 having a configuration as the sub link 22 and the coupling length variable mechanism 35 provided on the second link arm 12 will be described.

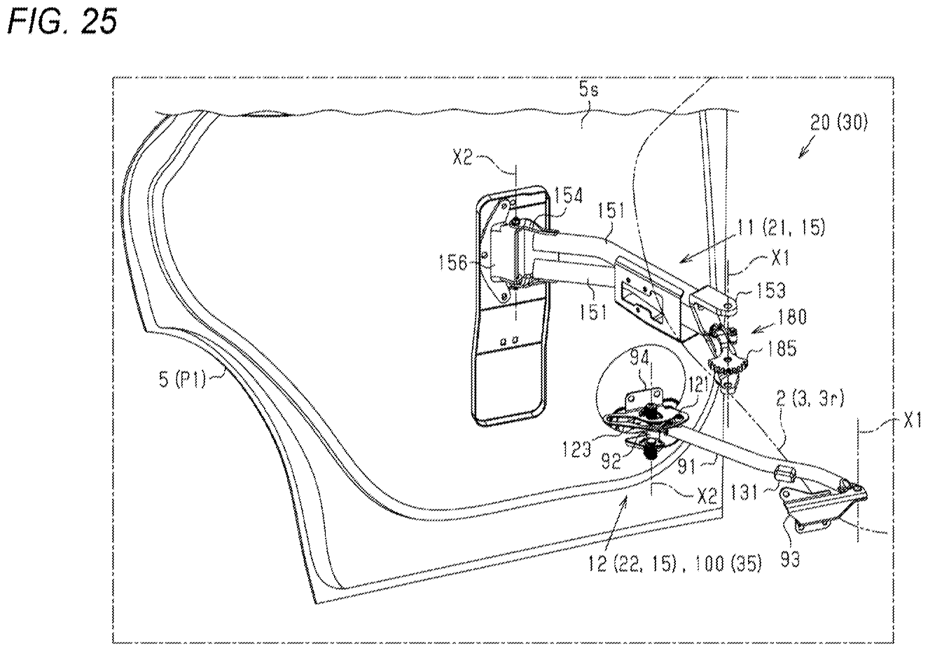

As shown in FIGS. 22 to 25, the second link arm 12 includes a vehicle-body-side link 91 having the first pivot coupling point X1 with respect to the vehicle body 2 and a door-side link 92 having the second pivot coupling point X2 with respect to the door 5. The vehicle-body-side link 91 is coupled to the vehicle body 2 via a vehicle-body bracket 93 provided in a vicinity of the rear edge portion 3r of the door opening portion 3. Furthermore, the door-side link 92 is coupled to the door 5 via a door bracket 94 fixed to an inner surface 5s of the door 5. The vehicle-body-side link 91 and the door-side link 92 are pivotably coupled to each other. A joint link mechanism 100 formed by the vehicle-body-side link 91 and the door-side link 92 constitutes the coupling length variable mechanism 35.

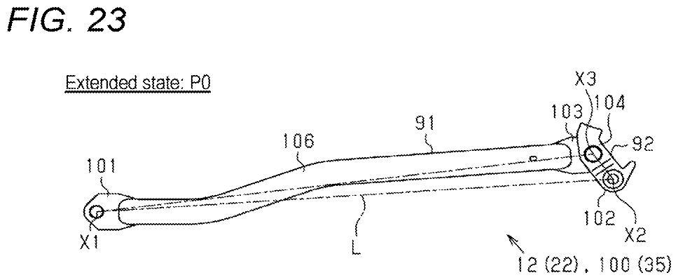

Specifically, as shown in FIGS. 22 and 23, the door-side link 92 of the present embodiment has a configuration as a so-called mini arm having a short axial direction length in comparison with the vehicle-body-side link 91. Furthermore, on a first end side in a longitudinal direction thereof, the vehicle-body-side link 91 has a vehicle-body-side coupling portion 101 coupled to the vehicle body 2. On a first end side in a longitudinal direction thereof, the door-side link 92 has a door-side coupling portion 102 coupled to the door 5. On a second end side in the longitudinal direction thereof, the vehicle-body-side link 91 and the door-side link 92 have an intermediate coupling portion 103 and an intermediate coupling portion 104, respectively. The intermediate coupling portions 103, 104 are coupled to each other.

These intermediate coupling portions 103, 104 form an intermediate coupling point X3 of the joint link mechanism 100. With the intermediate coupling point X3 as a vertex, the vehicle-body-side link 91 and the door-side link 92 form two sides of a triangle. A straight line connecting the first and second pivot coupling points X1, X2 forms the base of the triangle. As the vehicle-body-side link 91 and the door-side link 92 relatively pivot, a length of the straight line connecting the first and second pivot coupling points X1, X2, that is, the coupling length L, changes.

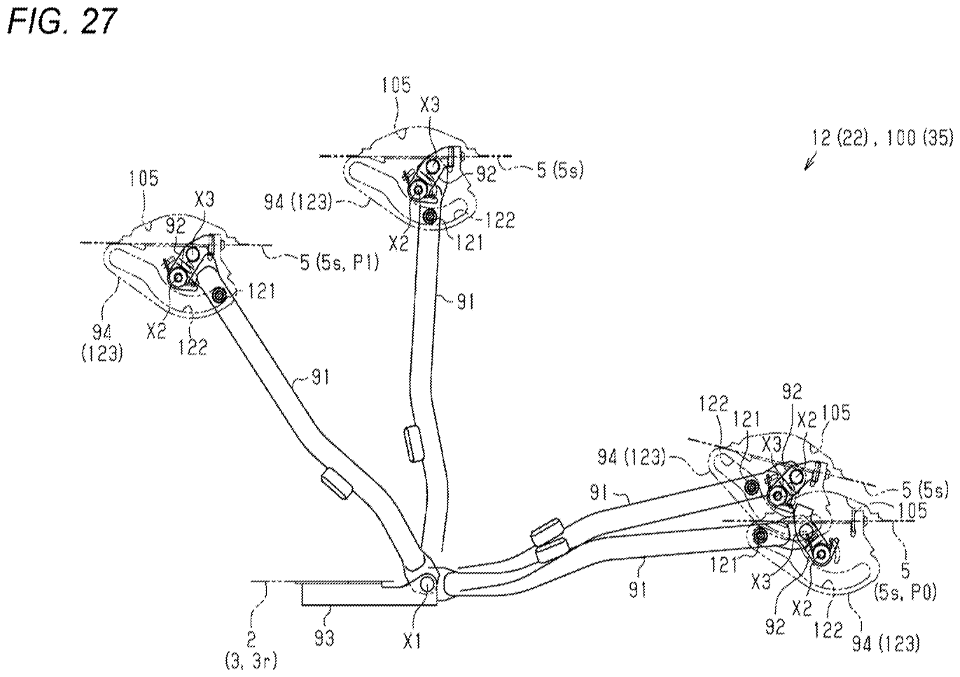

As shown in FIGS. 22, 23, 26, and 27, the intermediate coupling point X3 coupling the vehicle-body-side link 91 and the door-side link 92 is disposed at a position closer to the inner surface 5s of the door 5 than the second pivot coupling point X2 is with respect to the door 5. On the inner surface 5s of the door 5, there is formed a recess 105 for avoiding contact between the intermediate coupling portion 103 of the vehicle-body-side link 91 and the intermediate coupling portion 104 of the door-side link 92, and the door 5. The coupling length L between the vehicle body 2 and the door 5 changes in such a manner that the intermediate coupling point X3 apparently pivots about the second pivot coupling point X2 on the basis of the opening and closing motions of the door 5.

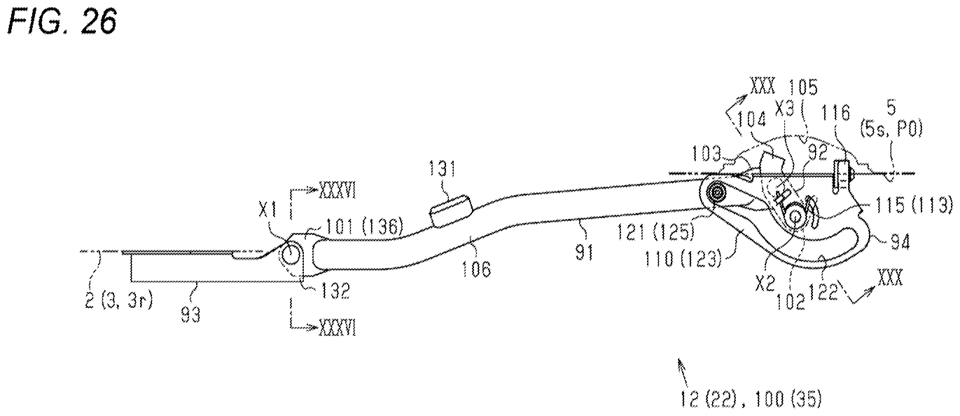

As shown in FIGS. 26 to 29, the vehicle-body-side link 91 of the present embodiment has a long and substantially shaft-like outer shape. Moreover, the vehicle-body-side link 91 has a bent-shaped portion 106 that is formed like a crank. Thus, interference between the second link arm 12 and the rear edge portion 3r of the door opening portion 3 is avoided, and a larger door opening amount when the door 5 performs a full opening motion is ensured.

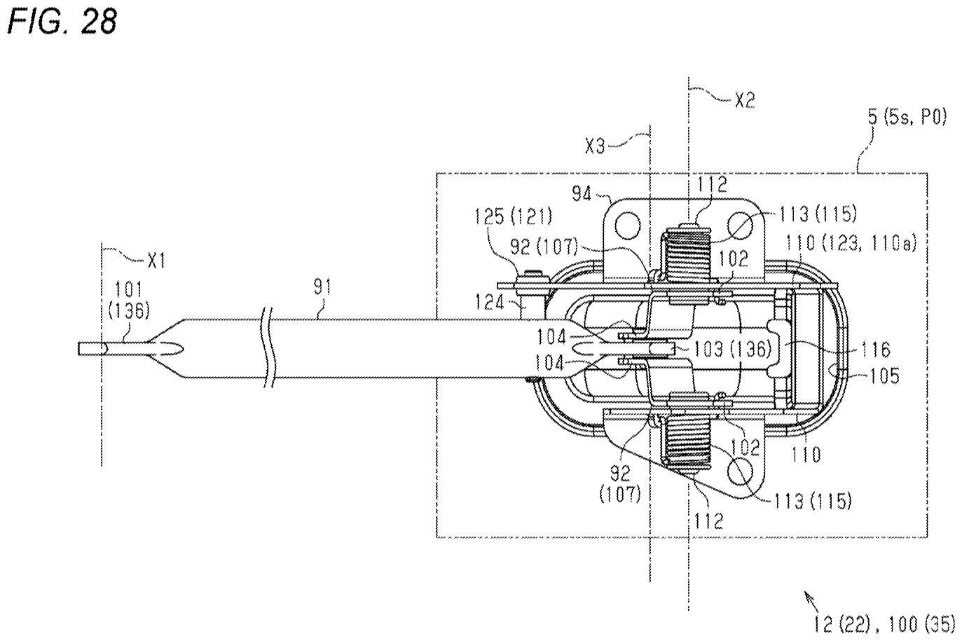

Furthermore, as shown in FIGS. 28 to 30, the door-side link 92 has a pair of holding portions 107, 107 pivotably coupled to the intermediate coupling portion 103 while sandwiching the intermediate coupling portion 103 of the vehicle-body-side link 91.

Each of the holding portions 107 having a bent-plate shape has the door-side coupling portion 102 coupled to the door 5 on the first end side in the longitudinal direction thereof, and has an intermediate coupling portion 104 coupled to the door-side link 92 on the second end side in the longitudinal direction thereof. The door-side link 92 is a single integral body formed by bending a metal plate material. The intermediate coupling portions 104, 104 are connected to each other by a connection portion 108. The intermediate coupling portion 103 of the vehicle-body-side link 91 has a substantially flat outer shape. The intermediate coupling portion 103 of the vehicle-body-side link 91 is sandwiched between the intermediate coupling portions 104, 104.

An interval between the two door-side coupling portions 102, 102 is larger than an interval between the two intermediate coupling portions 104, 104. Thus, both the holding portions 107, 107 are pivotably coupled to the door 5 at positions separated from each other in the up-down direction.

The door bracket 94 fixed to the inner surface 5s of the door 5 includes a pair of coupling walls 110, 110 having a substantially flat outer shape and facing each other in the up-down direction. The door-side coupling portions 102, 102 separated from each other in the up-down direction are coupled to the respective coupling walls 110, 110. The door-side coupling portions 102, 102 and the coupling walls 110, 110 form the second pivot coupling point X2.

Furthermore, the vehicle door apparatus 20 of the present embodiment includes a pair of support shafts 112, 112 provided coaxially with the second pivot coupling point X2. One of the support shafts 112, 112 protrudes upward from the coupling wall 110 of an upper side. Furthermore, another one of the support shafts 112, 112 protrudes downward from the coupling wall 110 of a lower side. Torsion coil springs 113, 113, each being a biasing member 115, are fitted into the respective support shafts 112, 112. The door-side link 92 is pivotally biased by these torsion coil springs 113, 113.

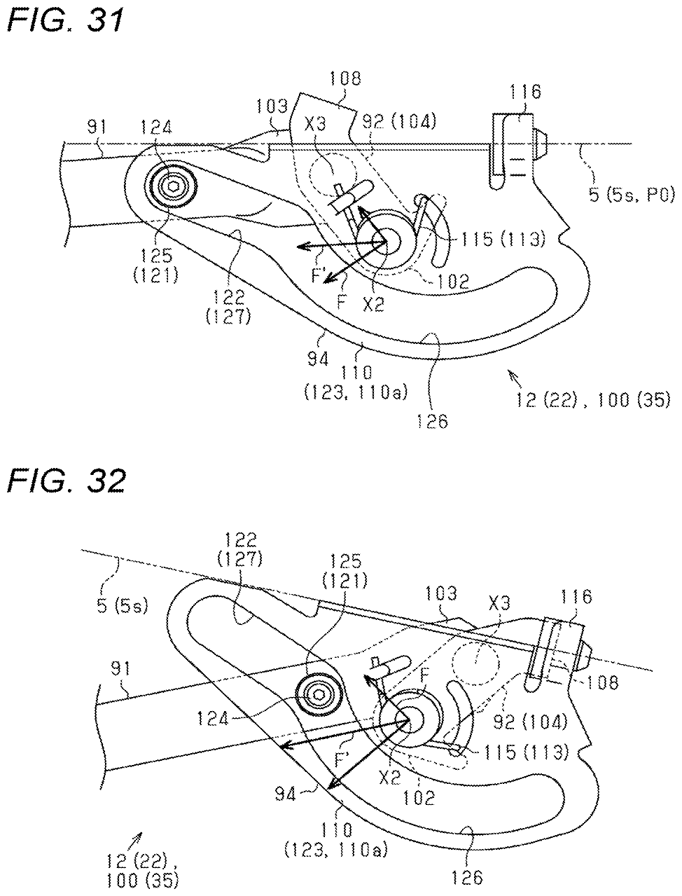

As shown in FIGS. 31 and 32, the torsion coil springs 113, 113 generate a biasing force F that causes the vehicle-body-side link 91 and the door-side link 92 to relatively pivot in a direction in which the coupling length L between the first and second pivot coupling points X1, X2 is shortened. The coupling length L becomes shorter than the coupling length L at the fully closed position P0 on the basis of the opening motion of the door 5 (refer to FIGS. 22 and 23). Thus, the door 5 performs opening and closing motions in a state where the coupling length L between the first and second pivot coupling points X1, X2 is shortened (refer to FIGS. 3 to 6).

As shown in FIGS. 28 and 30 to 32, the door bracket 94 is provided with a stopper 116. When the door 5 performs the opening motion from the fully closed position P0, the intermediate coupling point X3 apparently pivots about the second pivot coupling point X2, by which the stopper 116 abuts on the connection portion 108 of the door-side link 92. Thus, a stable opening and closing motion posture of the door 5 supported by the second link arm 12 is ensured.

Furthermore, as shown in FIGS. 31 and 32, the vehicle door apparatus 20 of the present embodiment is configured such that the biasing force F of the biasing member 115 changes on the basis of relative pivoting of the vehicle-body-side link 91 and the door-side link 92 that constitute the joint link mechanism 100. Specifically, the vehicle door apparatus 20 is configured such that, when the door 5 performs the opening motion from the fully closed position P0, a component force F′ of the biasing force F in the direction along a coupling length in the second link arm 12 is stronger than the component force F′ at the fully closed position P0. By reducing the component force F′ of the biasing force F in the direction along the coupling length in a case where the door 5 is in a fully closed state, a good construction of the door 5 is ensured.

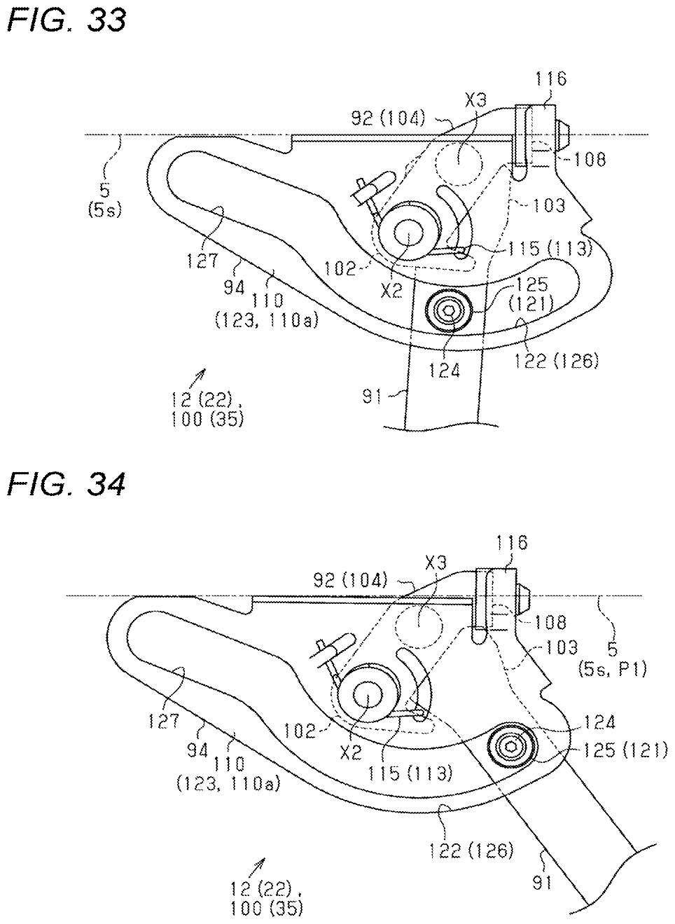

As shown in FIGS. 28 to 34, the vehicle door apparatus 20 of the present embodiment includes an engagement protrusion 121 provided on the vehicle-body-side link 91, and a cam member 123 having a cam groove 122 with which the engagement protrusion 121 engages, and provided on the door 5.

The vehicle-body-side link 91 includes a support shaft 124 provided in a vicinity of the intermediate coupling portion 103 and protruding upward, and a roller 125 rotatably supported by the support shaft 124. The roller 125 functions as the engagement protrusion 121.

The cam member 123 is provided integrally with the door bracket 94, specifically, a coupling wall 110a on an upper side. That is, the cam member 123 has a substantially flat outer shape. The cam member 123 is disposed above the vehicle-body-side link 91 and the door-side link 92 in such a manner as to cover an upper side of the intermediate coupling portions 103, 104. The cam member 123 includes the cam groove 122 penetrating the cam member 123 in the up-down direction.

The cam groove 122 has an arc-shaped portion 126 projecting inward in the vehicle width direction (lower side in FIGS. 31 to 34) in a state where the cam member 123 is fixed to the inner surface 5s of the door 5. Furthermore, the cam groove 122 has a linear portion 127 extending rearward continuously from the arc-shaped portion 126. The roller 125, which is the engagement protrusion 121, is disposed in the cam groove 122. On the basis of the opening and closing motions of the door 5, the roller 125 moves in the cam groove 122 while being in sliding contact with the cam groove 122.

When the door 5 is positioned in the vicinity of the fully closed position P0, the door-side engagement portion 31 and the vehicle-body-side engagement portion 32 are engaged with each other, by which the front end portion 5f of the door 5 draws the linear-shaped slide track Rs. At this time, the roller 125 moves in the linear portion 127 of the cam groove 122. When the door-side engagement portion 31 and the vehicle-body-side engagement portion 32 are disengaged, the front end portion 5f of the door 5 draws the arc-shaped glide track Rg and performs the opening and closing motions. In such a movement range of the door 5, the roller 125 moves in the arc-shaped portion 126 of the cam groove 122. In this manner, the opening and closing motion track R of the door 5 is defined.

The relative pivoting between the vehicle-body-side link 91 and the door-side link 92 is limited according to a position of the roller 125 in the cam groove 122. That is, the coupling length L between the first and second pivot coupling points X1, X2 based on the operation of the coupling length variable mechanism 35 is defined on the basis of the position of the roller 125 in the cam groove 122. Furthermore, the pivoting of the door 5 about the second pivot coupling point X2 of the door-side link 92 is restricted on the basis of the position of the roller 125 in the cam groove 122. Thus, the opening and closing motion track R of the door 5 is defined.

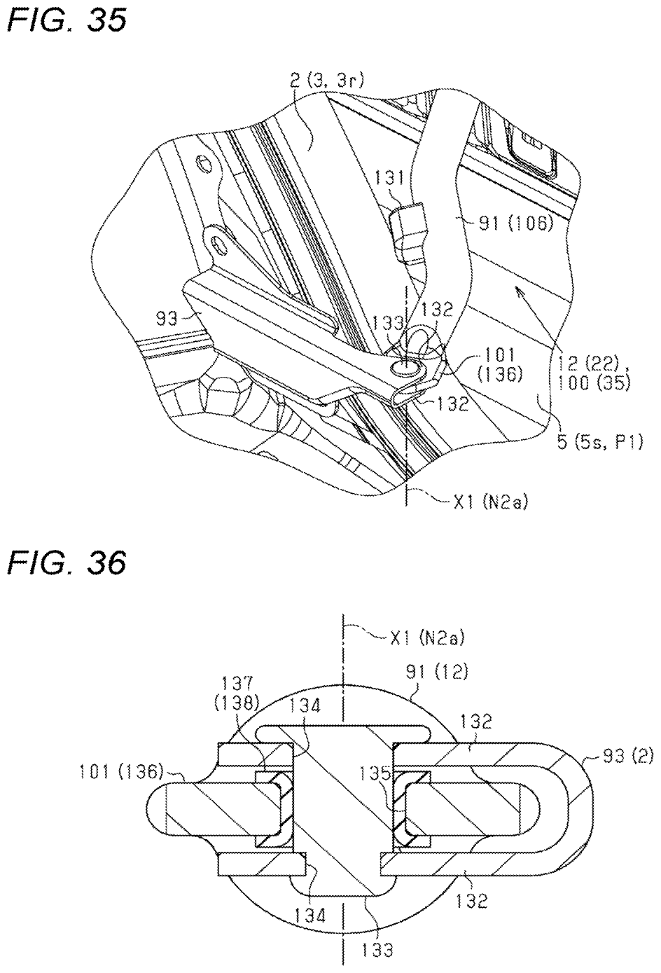

Furthermore, as shown in FIG. 35, the vehicle door apparatus 20 of the present embodiment includes a buffer member 131 as a stopper interposed between the vehicle body 2 and the second link arm 12 in a case where the door 5 is at a fully open position P1.

The buffer member 131 is configured with a relatively soft elastic member such as a rubber material or elastomer, for example. Furthermore, the buffer member 131 is provided on the vehicle-body-side link 91 having the first pivot coupling point X1 with respect to the vehicle body 2. Specifically, the buffer member 131 is fixed to the bent-shaped portion 106 that is formed like a crank and provided on the vehicle-body-side link 91. The buffer member 131 is sandwiched between the vehicle-body-side link 91 and the rear edge portion 3r of the door opening portion 3 when the second link arm 12 pivots about the first pivot coupling point X1 and the door 5 reaches the fully open position P1.

The buffer member 131 supports the door 5 that has reached the fully open position P1 on the vehicle body 2 while being crushed between the vehicle-body-side link 91 and the rear edge portion 3r of the door opening portion 3. Thus, the buffer member 131 stably holds the door 5 at the fully open position P1 while reducing shaking of the door 5.

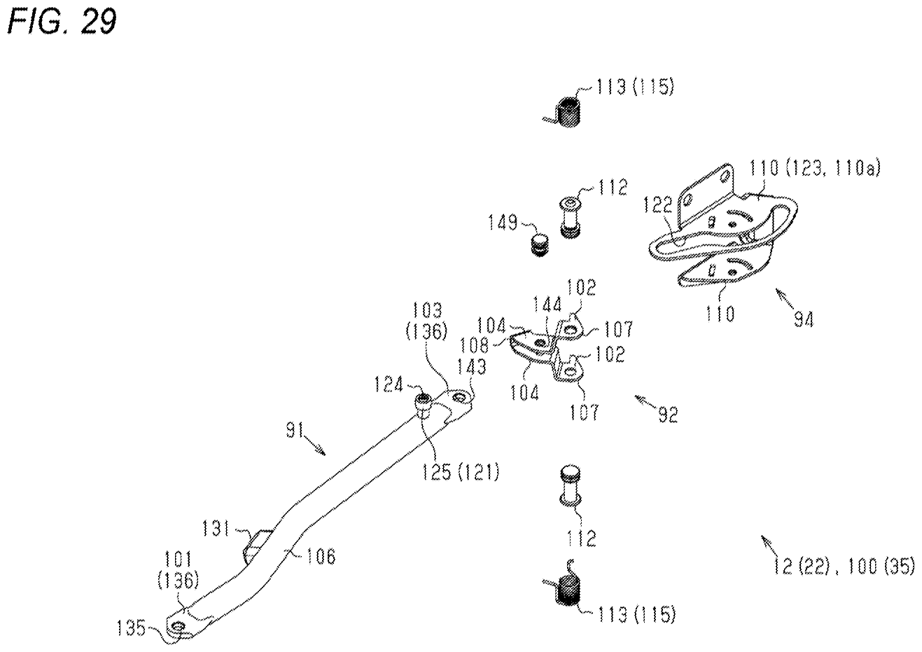

Furthermore, as shown in FIGS. 29, 35, and 36, the vehicle-body-side coupling portion 101 provided on the vehicle-body-side link 91 has a substantially flat outer shape. The vehicle-body bracket 93 that supports the vehicle-body-side link 91 on the vehicle body 2 has a pair of coupling walls 132, 132 sandwiching the vehicle-body-side coupling portion 101 in the up-down direction. A support shaft 133 penetrating the vehicle-body-side coupling portion 101 and both the coupling walls 132, 132 in the up-down direction forms a pivot axis of the vehicle-body-side link 91 with respect to the vehicle body 2. That is, the support shaft 133 forms the first pivot coupling point X1 that is the pivot axis N2a of the second link arm 12 with respect to the vehicle body 2.

The vehicle-body bracket 93 is formed by bending a metal plate material including both the coupling walls 132, 132. Furthermore, both the coupling walls 132, 132 of the vehicle-body bracket 93 and the vehicle-body-side coupling portion 101 of the vehicle-body-side link 91 are respectively provided with through holes 134, 134 and a through hole 135 penetrating the coupling walls 132, 132 and the vehicle-body-side coupling portion 101 respectively, in a thickness direction. The vehicle door apparatus 20 includes a bush 138 that is a cylindrical buffer member 137 fitted into the through hole 135 of the vehicle-body-side coupling portion 101. The vehicle-body-side coupling portion 101 has a configuration as a plate-shaped coupling portion 136.

The bush 138 is configured with a relatively soft elastic member such as a rubber material or elastomer. The support shaft 133 described above is inserted into the through hole 135 provided in the vehicle-body-side coupling portion 101 of the vehicle-body-side link 91 via the bush 138. Both end portions of the support shaft 133 in an axial direction are inserted into the through holes 134, 134 provided in both the coupling walls 132, 132 of the vehicle-body bracket 93. Thus, the support shaft 133 is supported by the vehicle-body bracket 93 while extending in the up-down direction.

The vehicle-body-side link 91 pivots about the support shaft 133 forming the first pivot coupling point X1 of the second link arm 12 with respect to the vehicle body 2. A gap is provided between the vehicle-body-side coupling portion 101 of the vehicle-body-side link 91 and both the coupling walls 132, 132 of the vehicle-body bracket 93, the coupling walls 132, 132 sandwiching the vehicle-body-side coupling portion 101 in the up-down direction. Elastic deformation of the bush 138, which is the cylindrical buffer member 137, allows displacement of the vehicle-body-side coupling portion 101. That is, displacement of the second link arm 12 in the up-down direction, including tilting with respect to the pivot axis N2a, is allowed. Thus, flexibility of coupling the second link arm 12 to the vehicle body 2 is increased.

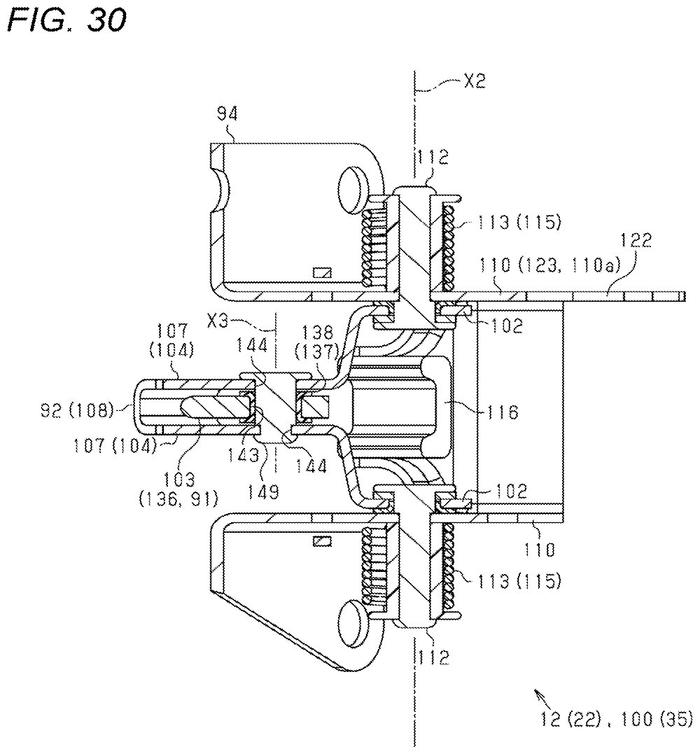

As shown in FIG. 30, the intermediate coupling point X3 formed by the intermediate coupling portion 103 of the vehicle-body-side link 91 and the intermediate coupling portion 104 of the door-side link 92 also has a similar coupling structure.

That is, the intermediate coupling portion 103 of the vehicle-body-side link 91 and both the intermediate coupling portions 104, 104 of the door-side link 92 sandwiching the intermediate coupling portion 103 in the up-down direction also have a substantially flat outer shape. Furthermore, the intermediate coupling portion 103 and the intermediate coupling portions 104, 104 are respectively provided with a through hole 143 and through holes 144, 144 penetrating the intermediate coupling portion 103 and the intermediate coupling portions 104, 104, respectively, in the thickness direction. The bush 138, which is the cylindrical buffer member 137, is fitted into the through hole 143 provided in the intermediate coupling portion 103 of the vehicle-body-side link 91. The intermediate coupling portion 103 of the vehicle-body-side link 91 has a configuration as the plate-shaped coupling portion 136.

The vehicle door apparatus 20 has a support shaft 149 inserted via the bush 138 into the through hole 143 provided in the intermediate coupling portion 103 of the vehicle-body-side link 91. Both side portions of the support shaft 149 in the axial direction are inserted into the through holes 144, 144 provided in both the intermediate coupling portions 104, 104 of the door-side link 92. The vehicle-body-side link 91 and the vehicle-body-side link 91 relatively pivot about the support shaft 149 forming the intermediate coupling point X3.

Elastic deformation of the bush 138, which is the cylindrical buffer member 137, allows the intermediate coupling portion 103 of the vehicle-body-side link 91 to tilt with respect to the support shaft 149. Thus, flexibility of coupling between the vehicle-body-side link 91 and the door-side link 92 at the intermediate coupling point X3 is increased.

### (First Link Arm)

Next, configurations of the first link arm 11 having a configuration as the main link 21 will be described.

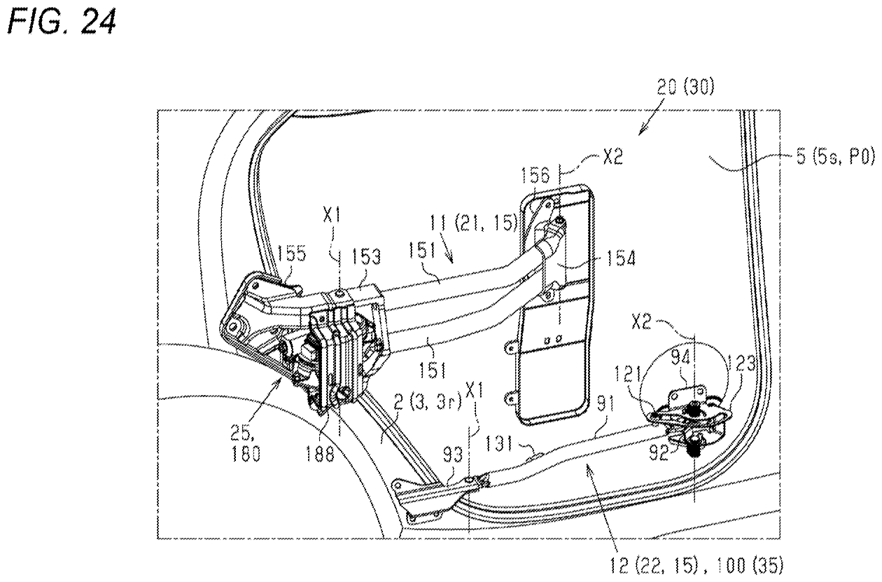

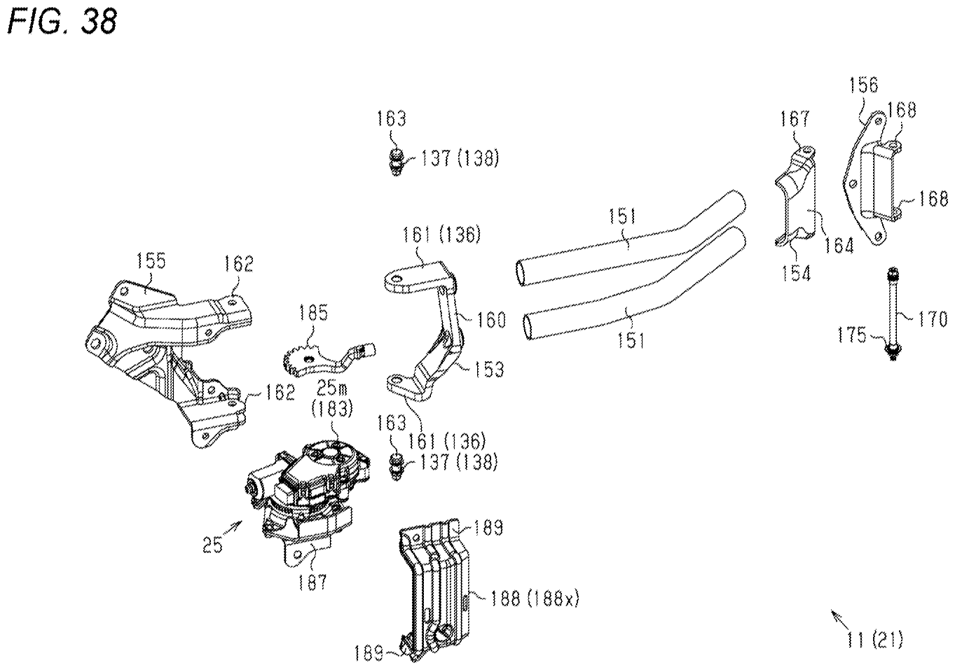

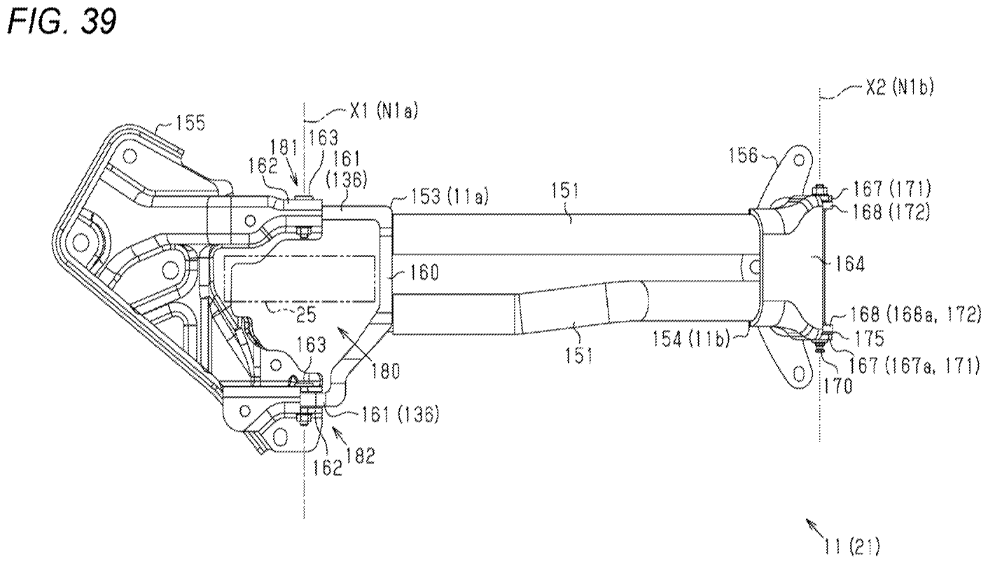

As shown in FIGS. 24 and 37 to 39, the first link arm 11 includes a pair of pipe frames 151, 151 arranged in the up-down direction. The first link arm 11 includes a base end bracket 153 connecting base end portions of both the pipe frames 151, 151 to each other, and a tip end bracket 154 connecting tip end portions of both the pipe frames 151, 151 to each other.

The vehicle door apparatus 20 includes a vehicle-body bracket 155 fixed to the vicinity of the rear edge portion 3r of the door opening portion 3 and to which the base end bracket 153 is pivotably coupled. Moreover, the vehicle door apparatus 20 includes a door bracket 156 fixed to the inner surface 5s of the door 5 and to which the tip end bracket 154 is pivotably coupled. Thus, the first and second pivot coupling points X1, X2 in the first link arm 11 are formed.

More specifically, the base end bracket 153 that constitutes a base end portion 11a of the first link arm 11 includes a base portion 160 extending in the up-down direction and coupling the pair of pipe frames 151, 151 to each other. Furthermore, the base end bracket 153 includes a pair of coupling portions 161, 161 extending from upper end and lower end of the base portion 160 to a side opposite to both the pipe frames 151, 151. The coupling portions 161, 161 have a configuration as the plate-shaped coupling portion 136. The vehicle-body bracket 155 is provided with a pair of coupling portions 162, 162 to which both the coupling portions 161, 161 are independently coupled. Both the coupling portions 161, 161 of the base end bracket 153 are pivotably coupled to the corresponding coupling portions 162, 162 of the vehicle-body bracket 155 by separate support shafts 163, 163 extending in the up-down direction.

Thus, the base end portion 11a of the first link arm 11 is pivotably coupled to the vehicle body 2 at two positions separated from each other in the up-down direction. Both the support shafts 163, 163 form the first pivot coupling point X1 that is the pivot axis N1a of the first link arm 11 with respect to the vehicle body 2.

The bush 138, which is the cylindrical buffer member 137, is fitted into each of the coupling portions 161, 161 of the base end bracket 153, the coupling portions 161, 161 having a substantially flat plate shape. Each of the support shafts 163, 163 is inserted into the bush 138. Elastic deformation of the bush 138 allows displacement of each of the coupling portions 161, 161. Thus, displacement of the first link arm 11 in the up-down direction, including tilting with respect to the pivot axis N1a, is allowed. Therefore, flexibility of coupling the first link arm 11 to the vehicle body 2 is increased.

The tip end bracket 154 that constitutes a tip end portion 11b of the first link arm 11 has a cover-like outer shape covering tip end sides of the pair of pipe frames 151, 151. Specifically, the tip end bracket 154 includes a cover portion 164 that covers the tip end sides the pipe frames 151, 151 while being disposed on an inner side in the vehicle width direction than the pipe frames 151, 151. Each of the pipe frames 151, 151 is fixed to a back surface of the cover portion 164 by welding or the like, for example. In this manner, the tip end portions of both the pipe frames 151, 151 are connected to each other by the tip end bracket 154.

The tip end bracket 154 includes a pair of coupling flanges 167, 167 facing each other in the up-down direction. Each of both the coupling flanges 167, 167 is a first pivot coupling portion 171. The door bracket 156 fixed to the inner surface 5s of the door 5 also includes a pair of coupling flanges 168, 168 facing each other in the up-down direction. Each of both the coupling flanges 168, 168 is a second pivot coupling portion 172. Both the coupling flanges 167, 167 of the tip end bracket 154 are pivotably coupled to both the coupling flanges 168, 168 of the door bracket 156, by which the second pivot coupling point X2 in the first link arm 11 is formed.

Specifically, the vehicle door apparatus 20 includes a support shaft 170 penetrating both the coupling flanges 167, 167 of the tip end bracket 154 and both the coupling flanges 168, 168 of the door bracket 156 in the up-down direction. Both the coupling flanges 167, 167 of the tip end bracket 154 and both the coupling flanges 168, 168 of the door bracket 156 are relatively pivotably coupled to each other by the support shaft 170, by which the second pivot coupling point X2 is formed.

The vehicle door apparatus 20 includes a friction member 175 that is interposed between the first and second pivot coupling portions 171, 172 and is in sliding contact with the first and second pivot coupling portions 171, 172. The friction member 175 is formed with a resin material, such as nylon for example, having a relatively large frictional resistance. The friction member 175 is subjected to surface treatment to increase the frictional resistance. When the first and second pivot coupling portions 171, 172 forming the second pivot coupling point X2 relatively pivot, the friction member 175 applies sliding resistance to the first and second pivot coupling portions 171, 172.

Specifically, the coupling flanges 168, 168 of the door bracket 156 are disposed between both the coupling flanges 167, 167 of the tip end bracket 154 separated from each other in the up-down direction.

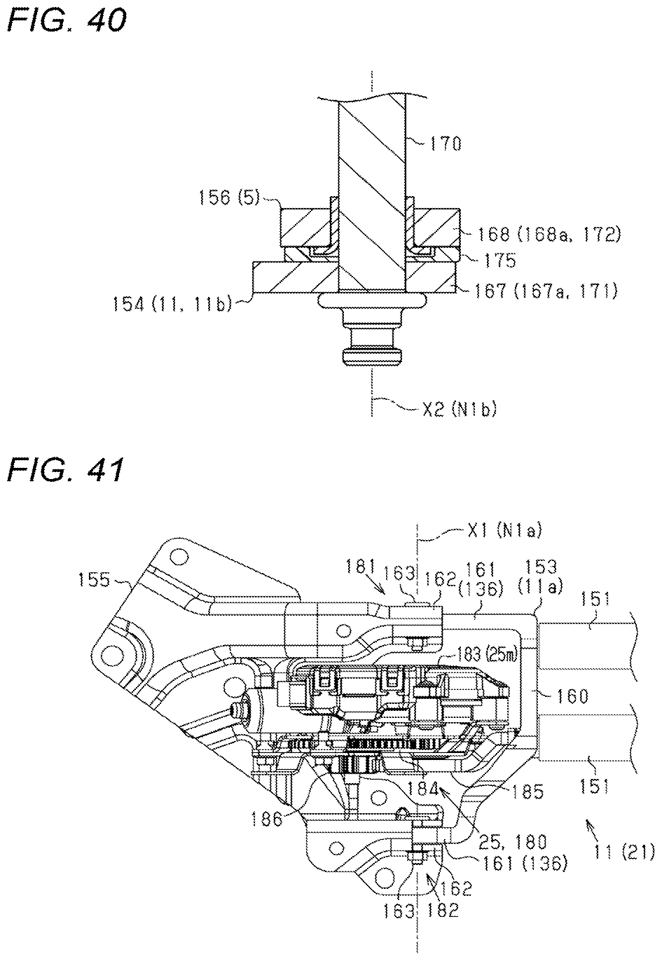

As shown in FIG. 40, a coupling flange 168a on a lower side of the door bracket 156 is disposed above a coupling flange 167a on a lower side of the tip end bracket 154. The friction member 175 has an annular plate-like shape and is disposed about the support shaft 170. The friction member 175 is sandwiched between the coupling flange 167a of the tip end bracket 154 and the coupling flange 168a of the door bracket 156, the coupling flange 167a and the coupling flange 168a overlapping each other in the up-down direction.

The load of the door 5 is applied to the friction member 175 via the coupling flange 168a of the door bracket 156, the coupling flange 168a being positioned above the friction member 175. Thus, a frictional force is generated between the friction member 175 and both the coupling flanges 167a and 168a sandwiching the friction member 175. When both the coupling flanges 167a and 168a relatively pivot, sliding resistance is generated. Thus, operational resistance of the door 5 pivoting about the second pivot coupling point X2 increases, and shaking and vibration generated in the door 5 attenuate.

### (Actuator)

Next, configurations of the actuator 25 will be described.

As described above, the actuator 25 that generates a drive force for causing the door 5 to perform opening and closing motions is provided on the base end portion 11a of the first link arm 11. The actuator 25 rotationally drives the first link arm 11 with the motor 25m. The door 5 is caused to perform opening and closing motions on the basis of a motion of the link mechanism 15 formed by the first link arm 11 and the second link arm 12 (refer to FIGS. 3 to 6).

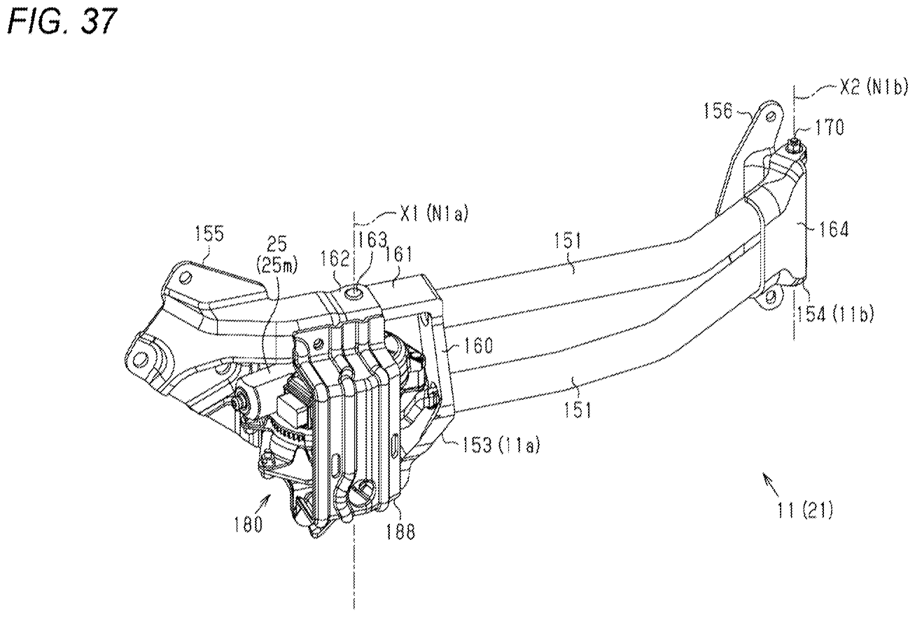

As shown in FIGS. 37 to 39 and 41, the first link arm 11 has a coupling point formation portion 180 forming the first pivot coupling point X1. The actuator 25 is disposed in the coupling point formation portion 180.

As described above, at two positions separated from each other in the up-down direction, the base end portion 11a of the first link arm 11 is pivotably coupled to the vehicle-body bracket 155 provided on the vehicle body 2. The actuator 25 is disposed between the upper and lower coupling portions 161, 161 of the first link arm 11 and between the upper and lower coupling portions 162, 162 of the vehicle-body bracket 155.

The actuator 25 is disposed in a space surrounded by the base end bracket 153 and the vehicle-body bracket 155, that is, in the coupling point formation portion 180. The first pivot coupling point X1 of the first link arm 11 has an upper coupling point 181 and a lower coupling point 182 that are separated from each other in the up-down direction. The actuator 25 is provided between the upper coupling point 181 and the lower coupling point 182 in the coupling point formation portion 180.

The motor 25m of the actuator 25 is a geared motor 183 with a speed reducer. The actuator 25 includes a speed reduction mechanism 184 that decelerates rotation of the motor 25m. The vehicle door apparatus 20 includes a sector gear 185 that protrudes from the base portion 160 of the base end bracket 153 and is disposed between both the coupling portions 161, 161. When a pinion gear 186 of the speed reduction mechanism 184 meshes with a sector gear 185, the drive force of the actuator 25 is transmitted to the first link arm 11.

The actuator 25 is fixed to the vehicle-body bracket 155 by using a fixing bracket 187. The vehicle door apparatus 20 includes a cover member 188 having an outer shape with a substantially U-shaped cross section. Flange portions 189, 189 provided on both ends of the cover member 188 are fixed to both the coupling portions 162, 162 of the vehicle-body bracket 155. The cover member 188 covers a side of the actuator 25 disposed in the coupling point formation portion 180.

Next, operation of the present embodiment will be described.

On the basis of the drive force of the actuator 25, the first link arm 11 having a configuration as the main link 21 pivots about the first pivot coupling point X1 with respect to the vehicle body 2. In conjunction with the first link arm 11, the second link arm 12 having a configuration as the sub link 22 pivots about the first pivot coupling point X1 with respect to the vehicle body 2. Thus, the door 5 supported by the link mechanism 15 formed by the first and second link arms 11, 12 performs the opening and closing motions.

In the second link arm 12, the vehicle-body-side link 91 having the first pivot coupling point X1 with respect to the vehicle body 2 and the door-side link 92 having the second pivot coupling point X2 with respect to the door 5 are relatively pivotably coupled to each other. Thus, the second link arm 12 forms the coupling length variable mechanism 35. The vehicle-body-side link 91 and the door-side link 92 form the joint link mechanism 100 having the intermediate coupling point X3. The coupling length L between the first and second pivot coupling points X1, X2 changes on the basis of the relative pivoting of the vehicle-body-side link 91 and the door-side link 92 about the intermediate coupling point X3. On the basis of the operation of the coupling length variable mechanism 35, the opening and closing motion track R of the door 5 supported by the vehicle body 2 via the link mechanism 15 changes.

Next, effects of the present embodiment will be described.

(1) According to the configuration described above, flexibility of the opening and closing motions of the door 5 can be increased with a simple configuration.

That is, the vehicle-body-side link 91 and the door-side link 92 form the two sides of the triangle having the intermediate coupling point X3 of the joint link mechanism 100 as the vertex. A straight line connecting the first and second pivot coupling points X1, X2 forms the base of the triangle. A length of the base of the triangle is the coupling length L between the first and second pivot coupling points X1, X2. The coupling length L changes on the basis of a motion of the joint link mechanism 100 that functions as the coupling length variable mechanism 35. For example, in the vicinity of the fully closed position P0 of the door 5, the opening and closing motion track R of the door 5 can be changed from the arc-shaped glide track Rg to the linear-shaped slide track Rs. Thus, when the door 5 performs the opening motion from the fully closed position P0 or performs the closing motions to the fully closed position P0, the door 5 smoothly performs the opening and closing motions without interfering with the vehicle body 2.

(2) Furthermore, for example, the joint link mechanism 100 described above has a characteristic of being hardly affected by a use environment such as effects of foreign matters such dust and dirt or an effects of freezing. Therefore, the joint link mechanism 100 has high reliability and durability.

Moreover, the joint link mechanism 100 has an advantage that the vehicle-body-side link 91 and the door-side link 92 have high flexibility in shape. For example, the vehicle-body-side link 91 is formed into a bent shape to avoid interference between the vehicle-body-side link 91 and the door opening portion 3. Thus, a larger door opening amount when the door 5 performs the full opening motion is ensured.

(3) The door-side link 92 includes the pair of holding portions 107, 107 pivotably coupled to the vehicle-body-side link 91 while sandwiching the vehicle-body-side link 91. Both the holding portions 107, 107 are pivotably coupled to the door 5 independently at positions separated from each other in the up-down direction.

According to the configuration described above, high support stiffness of the door 5 can be ensured at the second pivot coupling point X2 formed between the vehicle-body-side link 91 and the door 5. Moreover, the door 5 is less likely to tilt with respect to the pivot axis formed at the second pivot coupling point X2. Thus, the door 5 can be stably supported.

(4) The vehicle door apparatus 20 includes the biasing member 115 that generates the biasing force F that causes the vehicle-body-side link 91 and the door-side link 92 to relatively pivot about the intermediate coupling point X3.

According to the configuration described above, by utilizing the biasing force F generated by the biasing member 115, the coupling length L between the first and second pivot coupling points X1, X2 can be maintained during the opening and closing motions of the door 5. Thus, shaking and vibration of the door 5 can be reduced, by which a stable opening and closing motions of the door 5 can be achieved.

(5) The joint link mechanism 100 is configured such that, when the door 5 performs the opening motion from the fully closed position P0, the component force F′ of the biasing force F in the direction along the coupling length is stronger than the component force F′ at the fully closed position P0, on the basis of the relative pivoting of the vehicle-body-side link 91 and the door-side link 92.

According to the configuration described above, in a state where the door 5 performs the opening and closing motions, the coupling length L between the first and second pivot coupling points X1, X2 can be stably maintained by the component force F′ of the strong biasing force F in the direction along the coupling length. Thus, a stable opening and closing motions of the door 5 can be achieved.

Furthermore, in a case where the door 5 is at the fully closed position P0, the component force F′ of the biasing force F in the direction along the coupling length decreases. That is, in a case where the door 5 is in the fully closed state, the door 5 can be stably held without relying on the biasing force F of the biasing member 115. Therefore, in a case where the door 5 is at the fully closed position P0, it is possible to ensure a good construction of the door 5 by reducing the component force F′ of the biasing force F in the direction along the coupling length.

(6) The vehicle door apparatus 20 includes the engagement protrusion 121 provided on the second link arm 12 so as to be combined with the coupling length variable mechanism 35, and the cam member 123 having the cam groove 122 with which the engagement protrusion 121 is engaged, and provided on the door 5. The opening and closing motion track R of the door 5 is defined by the engagement protrusion 121 moving in the cam groove 122 on the basis of the opening and closing motions of the door 5.

According to the configuration described above, for example, an intended opening and closing motion track R can be achieved by reducing a clearance between the vehicle body 2 and the door 5 during the opening and closing motions of the door 5. Moreover, for example, it is possible to reduce a change in the opening and closing motion track R due to an external force or the like. Thus, interference between the door 5 and the vehicle body 2 can be avoided, and good feeling of operating the door 5 is ensured.

In addition, the roller 125 provided on the engagement protrusion 121 is in sliding contact with the cam groove 122, by which the engagement protrusion 121 can smoothly move in the cam groove 122.

(7) The cam groove 122 is configured to define the coupling length L between the first and second pivot coupling points X1, X2 based on the operation of the coupling length variable mechanism 35 on the basis of a position of the engagement protrusion 121 in the cam groove 122.

According to the configuration described above, the coupling length L can be set corresponding to a position of the opening and closing motions of the door 5. Thus, the opening and closing motion track R of the door 5 can be freely set. In a case where an external force is applied to the door 5, the coupling length L corresponding to a position of the opening and closing motions of the door 5 is also maintained. Thus, shaking and vibration of the door 5 can be reduced, by which the opening and closing motion posture of the door 5 can be stably maintained.

(8) The cam groove 122 is configured to restrict pivoting of the door 5 about the second pivot coupling point X2 according to the position of the engagement protrusion 121 in the cam groove 122.

According to the configuration described above, in a case where an external force is applied to the door 5, a pivoting posture of the door 5 about the second pivot coupling point X2 corresponding to a position of the opening and closing motions of the door 5 is also maintained. Thus, shaking and vibration of the door 5 can be reduced, by which the opening and closing motion posture of the door 5 can be stably maintained.

(9) The cam member 123 is provided integrally with the door bracket 94 fixed to the door 5 and forming the second pivot coupling point X2. Thus, the configuration can be simplified and space saving can be achieved.

(10) The vehicle door apparatus 20 includes the buffer member 131 sandwiched between the second link arm 12 and the vehicle body 2 in a case where the door 5 is at the fully open position P1.

According to the configuration described above, it is possible to stably hold the door 5 at the fully open position P1 while reducing shaking and vibration of the door 5 that has reached the fully open position P1.

(11) The vehicle-body-side coupling portion 101 of the vehicle-body-side link 91 forming a base end portion of the second link arm 12 has a configuration as the plate-shaped coupling portion 136 having a substantially flat plate shape. Furthermore, the vehicle-body-side coupling portion 101 is provided with the through hole 135 penetrating the vehicle-body-side coupling portion 101 in the thickness direction. The bush 138, which is the cylindrical buffer member 137, is fitted into the through hole 135. The first pivot coupling point X1 of the second link arm 12 includes the support shaft 133 inserted into the through hole 135 of the vehicle-body-side coupling portion 101 via the bush 138.

According to the configuration described above, the pivoting of the second link arm 12 about the support shaft 133 is allowed. Elastic deformation of the bush 138 allows displacement of each of the vehicle-body-side coupling portion 101. That is, displacement of the second link arm 12 in the up-down direction, including tilting with respect to the support shaft 133, is allowed. Thus, flexibility of coupling the second link arm 12 to the vehicle body 2 can be increased with a simple configuration. For example, a motion using a universal joint such as a ball joint can be reproduced in a pseudo manner. As a result, for example, assemblability can be improved by absorbing a manufacturing tolerance, an assembly tolerance, or the like.

(12) The vehicle door apparatus 20 includes the first and second pivot coupling portions 171, 172 relatively pivotably coupled to each other. The first and second pivot coupling portions 171, 172 form the second pivot coupling point X2 of the first link arm 11 with respect to the door 5. The vehicle door apparatus 20 includes the friction member 175 that is interposed between the first and second pivot coupling portions 171, 172. The friction member 175 applies sliding resistance to the first and second pivot coupling portions 171, 172 by coming into sliding contact with the first and second pivot coupling portions 171, 172.

According to the configuration described above, it is possible to increase operational resistance generated when the door 5 pivots about the second pivot coupling point X2. Thus, the shaking and vibration generated in the door 5 are attenuated, by which the opening and closing motion posture of the door 5 can be stably maintained.

(13) The vehicle door apparatus 20 includes the door-side engagement portion 31 provided on the closing-side end portion 33 of the door 5. The vehicle door apparatus 20 includes the vehicle-body-side engagement portion 32 provided on the closing-side end portion 34 where the closing-side end portion 33 of the door 5 approaches or leaves, the closing-side end portion 34 being a portion of the door opening portion 3. The door-side engagement portion 31 includes the shaft-shaped engagement portion 41 extending in the up-down direction of the vehicle 1. The vehicle-body-side engagement portion 32 includes the guide groove 42 having the pair of side wall portions 42a, 42b facing each other in the vehicle width direction, and extending in the opening and closing motion directions of the door 5. When the door 5 is positioned in the vicinity of the fully closed position P0, the door-side engagement portion 31 and the vehicle-body-side engagement portion 32 are engaged with each other, and the shaft-shaped engagement portion 41 is disposed in the guide groove 42.

According to the configuration described above, displacement of the door 5 in the vehicle width direction is restricted by the shaft-shaped engagement portion 41 being disposed in the guide groove 42. Thus, the door 5 can be stably supported also in the vicinity of the fully closed position P0 where the first and second link arms 11, 12 are likely to come close to each other and be linearly aligned.

In a state where the door-side engagement portion 31 and the vehicle-body-side engagement portion 32 are engaged with each other, on the basis of the operation of the coupling length variable mechanism 35, the opening and closing motion track R of the door 5 changes from the arc-shaped glide track Rg to the slide track Rs having a linear shape. Thus, it is possible to cause the door 5 to smoothly perform the closing motion to the fully closed position P0 or the opening motion from the fully closed position P0.

(14) The vehicle door apparatus 20 includes the actuator 25 that applies a drive force to the link mechanism 15 formed by the first and second link arms 11, 12 to cause the door 5 to perform the opening and closing motions. Thus, convenience can be improved.

(15) The actuator 25 applies the drive force to the first link arm 11 not provided with the coupling length variable mechanism 35.

According to the configuration described above, because the actuator 25 applies the drive force to the first link arm 11 at the time of opening and closing drive of the door 5, vibration based on the drive force is less likely to be generated in the second link arm 12 having the coupling length variable mechanism 35. That is, if the drive force is applied to the second link arm 12, there is a possibility that the coupling length variable mechanism 35 operates due to the drive force of the actuator 25, that is, for example, the coupling length L extends before the opening and closing motions of the door 5 due to inertia of the door 5, or operational resistance such as a frictional force. Thus, vibration may occur in the second link arm 12, and the door 5 may shake. However, such a problem does not occur in the first link arm 11 not including the coupling length variable mechanism 35. Therefore, if the actuator 25 applies the drive force to the first link arm 11, shaking of the door 5 caused by the drive force of the actuator 25 can be reduced. As a result, it is possible to avoid complication of the configurations and an increase in weight caused by taking measures against shaking of the door 5.

(16) The second pivot coupling point X2 of the first link arm 11 is at a position closer to the center of gravity G of the door 5 than the second pivot coupling point X2 of the second link arm 12.

According to the configuration described above, the door 5 can be stably supported by the first link arm 11 positioned as the main link 21 that supports larger load. By applying the drive force of the actuator 25 to the first link arm 11, it is possible to reduce shaking of the door 5 and can perform opening and closing drive of the door 5 stably.

(17) The actuator 25 is provided in the coupling point formation portion 180 forming the first pivot coupling point X1.

By providing the actuator 25 at the base end portion 11a of the first link arm 11, support load applied to the first link arm 11 can be reduced. Furthermore, a relatively large installation space can be ensured in comparison with a case where the actuator 25 is disposed at the tip end portion 11b of the first link arm 11. By integrating the actuator 25 with the coupling point formation portion 180, a compact apparatus can be implemented.

(18) The first pivot coupling point X1 of the first link arm 11 has the upper coupling point 181 and a lower coupling point 182 provided to be separate from each other in the up-down direction. The actuator 25 is provided between the upper coupling point 181 and the lower coupling point 182.

According to the configuration described above, the base end portion 11a of the first link arm 11 can be stably supported with respect to the vehicle body 2. Moreover, the actuator 25 can be disposed in the coupling point formation portion 180 with a simple configuration. Thus, the actuator 25 and the first pivot coupling point X1 can be integrally configured.

### Second Embodiment

Hereinafter, a second embodiment of a vehicle door apparatus will be described with reference to the drawings. Note that, for convenience of description, similar components to those in the first embodiment described above are denoted by the same reference signs, and description thereof is omitted.

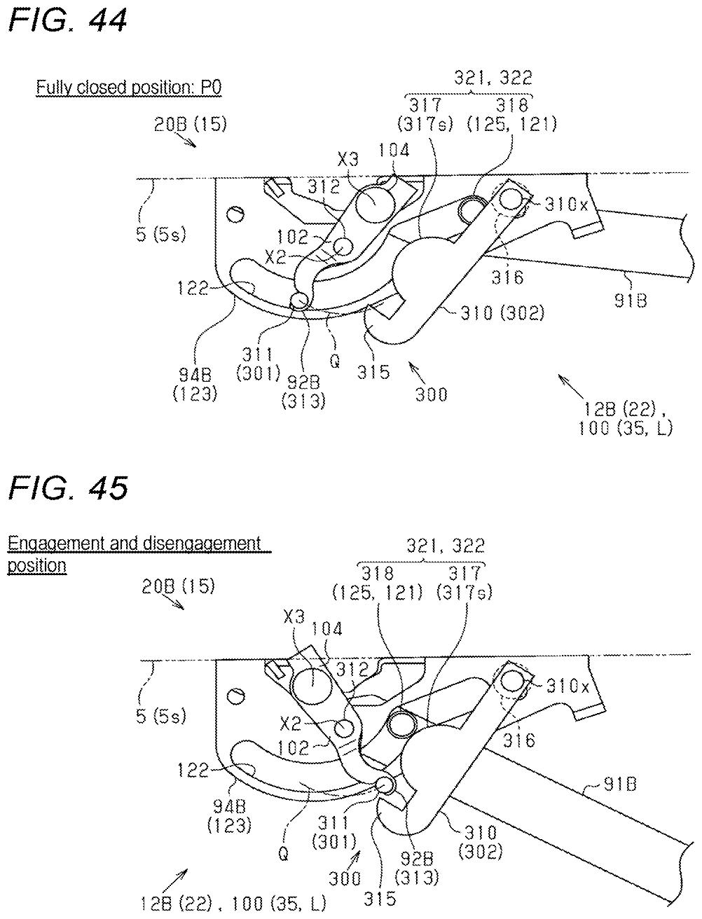

As shown in FIGS. 44 to 46, a vehicle door apparatus 20B of the present embodiment includes a second link arm 12B provided with a coupling length variable mechanism 35, and a coupling length fixing mechanism 300 in which a coupling length L between first and second pivot coupling points X1, X2 can be fixed. Note that, in these drawings, the left side is a front side of a vehicle, and the right side is a rear side of the vehicle.

In the vehicle door apparatus 20B of the present embodiment, the torsion coil spring 113 according to the first embodiment described above is not provided for a joint link mechanism 100 that constitutes the coupling length variable mechanism 35 (refer to FIGS. 30 and 31). That is, the vehicle door apparatus 20B of the present embodiment does not have a biasing member 115 that applies, to a vehicle-body-side link 91B and a door-side link 92B, a biasing force F in a direction of causing the vehicle-body-side link 91B and the door-side link 92B to relatively pivot.

As described above, in the vehicle door apparatus 20 according to the first embodiment, the door 5 performs opening and closing motions in a state where the coupling length L of the second link arm 12B is shortened on the basis of elastic force of the torsion coil spring 113.

Meanwhile, in the vehicle door apparatus 20B of the present embodiment, a coupling length L of the second link arm 12B is fixed by operation of the coupling length fixing mechanism 300 when a door 5 performs the opening and closing motions. Thus, it is possible to cause the door 5 supported by a link mechanism 15 to perform the opening and closing motions more stably.

The coupling length fixing mechanism 300 includes a first engagement member 301 provided on the door-side link 92B and a second engagement member 302 provided on the door 5. on the basis of the opening and closing motions of the door 5, the first engagement member 301 and the second engagement member 302 are engaged with each other. on the basis of engagement force of the first engagement member 301 and the second engagement member 302, the door-side link 92B is fixed to the door 5. Thus, relative pivoting of the door-side link 92B with respect to the door 5 is restricted, by which a coupling length L between the door 5 and the vehicle body 2 is fixed.

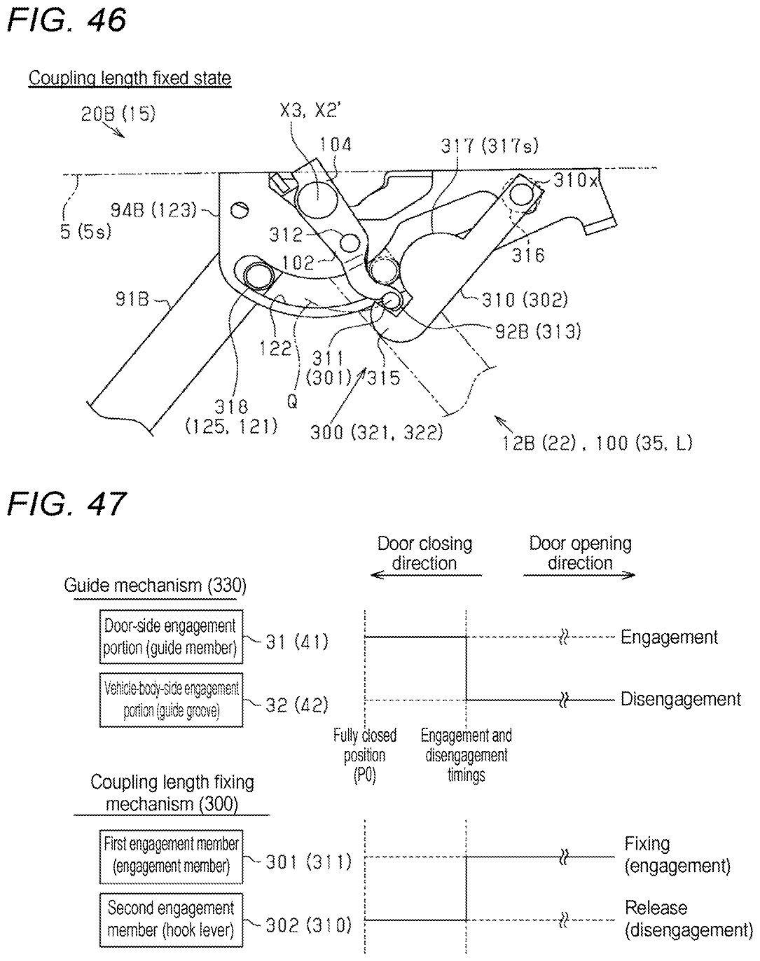

In a configuration in which the joint link mechanism 100 having a vehicle-body-side link 91 and a door-side link 92 relatively pivotably coupled to each other is used for the coupling length variable mechanism 35, the door-side link 92B is fixed to the door 5. Therefore, the door-side link 92B is integrated with the door 5. Moreover, the door 5 performs the opening and closing motions while the vehicle-body-side link 91 relatively pivots about an intermediate coupling point X3 with respect to a door-side link 92. That is, the intermediate coupling point X3 is a new second pivot coupling point X2′ with respect to the door 5 (refer to FIG. 46). In other words, the second pivot coupling point X2 with respect to the door 5 transitions. Thus, the coupling length L between the first and second pivot coupling points X1, X2 is fixed to a constant value based on a length of the vehicle-body-side link 91.

Note that, also in the vehicle door apparatus 20 according to the first embodiment described above, the intermediate coupling point X3 is a substantially new second pivot coupling point X2′ by pressing the door-side link 92 against the door 5 with the biasing force F of the biasing member 115. However, in this case, there is a possibility that the door-side link 92 pressed against the door 5 pivots against the biasing force F of the biasing member 115 by input of an external force. This may cause a change in the coupling length L, by which shaking and vibration of the door 5 may occur.

Based on this point, in the vehicle door apparatus 20B of the present embodiment, the coupling length L between the door 5 and the vehicle body 2 is fixed by the operation of the coupling length fixing mechanism 300. Thus, shaking and vibration of the door 5 is reduced, by which an opening and closing motion posture of the door 5 is stably maintained.

The vehicle door apparatus 20B of the present embodiment includes a support shaft 310x provided on a door bracket 94B integrally fixed to the door 5, and a hook lever 310 pivotably supported by the support shaft 310x. Furthermore, the vehicle door apparatus 20B includes an engagement protrusion 311 provided on the door-side link 92B. The engagement protrusion 311 is the first engagement member 301, and the hook lever 310 is the second engagement member 302 provided on the door 5.

The door bracket 94B has a support shaft 312 that pivotably supports a door-side coupling portion 102 of the door-side link 92B. The door-side link 92B has an extending portion 313 extending from the door-side coupling portion 102 to a side opposite to an intermediate coupling portion 104 forming the intermediate coupling point X3. The engagement protrusion 311 is provided on a tip end portion of the extending portion 313.

Meanwhile, at a tip end portion thereof, the hook lever 310 has an engagement portion 315 having a hook shape. The hook lever 310 is pivotally biased on the basis of elastic force of a torsion coil spring 316 disposed about the support shaft 310x. Thus, the engagement portion 315 of the hook lever 310 is disposed on a movement track Q of the engagement protrusion 311.

The engagement protrusion 311 moves drawing a track having an arc shape centered on the support shaft 312 by the door-side link 92B pivoting about the support shaft 312 on the basis of the opening and closing motions of the door 5. Because the engagement portion 315 of the hook lever 310 is positioned on the movement track Q of the engagement protrusion 311, the hook lever 310 and the engagement protrusion 311 are engaged with each other on the basis of the opening and closing motions of the door 5.

The vehicle door apparatus 20B includes a hook cam 317 provided on the hook lever 310. Similarly to the door bracket 94 in the first embodiment described above, the door bracket 94B has a configuration as a cam member 123 having a cam groove 122 with which a roller 125, which is an engagement protrusion 121 provided on the vehicle-body-side link 91, is engaged. Then, in a state where the engagement portion 315 is disposed on the movement track Q of the engagement protrusion 311, the hook cam 317 is disposed so as to overlap the cam groove 122 of the door bracket 94B.

The vehicle door apparatus 20B has a pressing protrusion 318 provided integrally with the engagement protrusion 121. The pressing protrusion 318 is formed by extending the roller 125 engaged with the cam groove 122 in an axial direction. The pressing protrusion 318 is engaged with and disengaged from the hook cam 317 of the hook lever 310 on the basis of the opening and closing motions of the door 5. Thus, the hook lever 310 pivots against a biasing force of the torsion coil spring 316 as a biasing member.

The pressing protrusion 318 provided on the vehicle-body-side link 91 moves along the cam groove 122 of the door bracket 94B by the vehicle-body-side link 91 pivoting on the basis of the opening and closing motions of the door 5. The extending portion 313 of the door-side link 92B has a three-dimensional shape that does not interfere with the pressing protrusion 318 that moves along the cam groove 122. By being engaged with the hook cam 317, the pressing protrusion 318 moves in the cam groove 122 while pivoting the hook lever 310 in such a manner as to push away the hook cam 317 (counterclockwise in each drawing). The hook cam 317 has a cam surface 317s having a semicircular shape and overlapping with the cam groove 122. When the pressing protrusion 318 is disengaged from the hook cam 317, the hook lever 310 pivots again on the basis of the biasing force of the torsion coil spring 316 (clockwise in each drawing). Thus, the engagement portion 315 of the hook lever 310 returns to the movement track Q of the engagement protrusion 311.

The engagement portion 315 of the hook lever 310 is disposed at a specific position on the movement track Q. The vehicle door apparatus 20B is configured such that the hook lever 310 pivots to the specific position on the movement track Q at a timing when the engagement protrusion 311 moves to the specific position. Thus, the hook lever 310 provided on the door 5 is smoothly engaged with and disengaged from the engagement protrusion 311 provided on the door-side link 92B.

In this manner, the vehicle-body-side link 91B pivots on the basis of the opening and closing motions of the door 5, by which the hook cam 317 and the pressing protrusion 318 are relatively displaced, and engaged with and disengaged from each other on the basis of the relative displacement. The hook cam 317 and the pressing protrusion 318 form a timing generation unit 321 and an engagement and disengagement drive unit 322.

That is, engagement and disengagement timings of the hook lever 310 as the second engagement member 302 with respect to the engagement protrusion 311 as the first engagement member 301 are generated by the hook cam 317 and the pressing protrusion 318 being engaged with and disengaged from each other on the basis of the opening and closing motions of the door 5. The hook lever 310 is engaged with and disengaged from the engagement protrusion 311 on the basis of the generated engagement and disengagement timings.

The engagement and disengagement timings between the engagement protrusion 311 and the hook lever 310 are set in accordance with the engagement and disengagement timings between a door-side engagement portion 31 provided on the door 5 and a vehicle-body-side engagement portion 32 provided on the door opening portion 3. That is, the coupling length fixing mechanism 300 of the present embodiment is configured to release the fixing of the coupling length L when the door 5 is positioned in a vicinity of a fully closed position P0 where the door-side engagement portion 31 and the vehicle-body-side engagement portion 32 are engaged with each other (refer to FIGS. 3 and 4). Thus, an opening and closing motion track R of the door 5 changes on the basis of operation of the coupling length variable mechanism 35 provided on the second link arm 12B.

That is, when the door 5 moves to the fully closed position P0, the door-side engagement portion 31 is engaged with the vehicle-body-side engagement portion 32, by which the opening and closing motions of the door 5 is guided in a state where a shaft-shaped engagement portion 41 is disposed in a guide groove 42. Thus, an arc-shaped glide track Rg based on a motion of the link mechanism 15 changes to a slide track Rs having a linear shape and along an opening width direction of the door opening portion 3.

As shown in FIG. 47, in a case where the door 5 is at the fully closed position P0, the door-side engagement portion 31 and the vehicle-body-side engagement portion 32, which constitute a guide mechanism 330, are engaged with each other. At this time, the coupling length fixing mechanism 300 is in a state where the engagement protrusion 311 and the hook lever 310 are disengaged, that is, in a state where fixing of the coupling length L is released.

On the basis of an opening motion of the door 5 moving from the fully closed position P0, engagement between the door-side engagement portion 31 and the vehicle-body-side engagement portion 32, which constitute the guide mechanism 330, is released. That is, the shaft-shaped engagement portion 41 provided on the door-side engagement portion 31 is disengaged from the guide groove 42 that constitutes the vehicle-body-side engagement portion 32. At this disengagement timing, the engagement protrusion 311 provided on the door-side link 92B is engaged with the hook lever 310 provided on the door 5. Thus, the coupling length fixing mechanism 300 shifts to a state where the coupling length L is fixed.

On the basis of a closing motion of the door 5 moving to the fully closed position P0, the door-side engagement portion 31 and the vehicle-body-side engagement portion 32 are engaged with each other. That is, the shaft-shaped engagement portion 41 provided on the door-side engagement portion 31 enters the guide groove 42 that constitutes the vehicle-body-side engagement portion 32. At this entry timing, the engagement between the engagement protrusion 311 provided on the door-side link 92B and the hook lever 310 provided on the door 5 is released. Thus, the coupling length fixing mechanism 300 shifts to a state where the fixing of the coupling length L is released.

As described above, also with the configuration according to the present embodiment, as in the first embodiment described above, it is possible to stably support the door 5 while securing smooth opening and closing motions of the door 5 in the vicinity of the fully closed position P0. In addition, the following characteristic effects can be obtained.

(1) By fixing the coupling length L between the door 5 and the vehicle body 2 with operation of the coupling length fixing mechanism 300, it is possible to stably support the door 5 during the opening and closing motions of the door 5. Thus, shaking and vibration of the door 5 can be reduced, by which a stable opening and closing motions of the door 5 can be achieved. As a result, for example, more excellent stability can be ensured in comparison with the configuration in which the coupling length L is maintained on the basis of the biasing force F of the biasing member 115.

(2) The coupling length fixing mechanism 300 includes the engagement protrusion 311, which is the first engagement member 301 provided on the door-side link 92B and the hook lever 310, which is the second engagement member 302 provided on the door 5. The coupling length fixing mechanism 300 fixes the coupling length L by the engagement protrusion 311 and the hook lever 310 being engaged with each other on the basis of the opening and closing motions of the door 5, and releases the fixing of the coupling length L by the engagement protrusion 311 and the hook lever 310 being disengaged from each other on the basis of the opening and closing motions of the door 5.

When the door-side link 92B is integrated with the door 5, the intermediate coupling point X3 between the door-side link 92B and the vehicle-body-side link 91 is a new second pivot coupling point X2′ with respect to the door 5. That is, the coupling length L is a constant value based on the length of the vehicle-body-side link 91. Therefore, according to the configuration described above, the coupling length L between the first and second pivot coupling points X1, X2 can be stably fixed with a simple configuration. Then, by adopting the configuration in which the hook lever 310 pivoting about the support shaft 310 is engaged with the engagement protrusion 311, the first engagement member 301 of the door-side link 92B and the second engagement member 302 of the door 5 can be stably engaged with and disengaged from each other with a simple configuration.

(3) The coupling length fixing mechanism 300 includes the timing generation unit 321 that generates the engagement and disengagement timings of the first engagement member 301 and the second engagement member 302, on the basis of the opening and closing motions of the door 5. Then, the coupling length fixing mechanism 300 includes the engagement and disengagement drive unit 322 that causes the first engagement member 301 and the second engagement member 302 to be engaged with and disengaged from each other on the basis of the generated engagement and disengagement timings.

According to the configuration described above, the engagement and disengagement timings between the first engagement member 301 and the second engagement member 302 can be adjusted by setting the timing generation unit 321 and the engagement and disengagement drive unit 322. Thus, the coupling length L between the door 5 and the vehicle body 2 can be fixed or have the fixing released accurately, on the basis of the opening and closing motions of the door 5.

(4) The coupling length fixing mechanism 300 includes the pressing protrusion 318 provided on the vehicle-body-side link 91B and the hook cam 317 provided on the hook lever 310. The pressing protrusion 318 and the hook cam 317 are relatively displaced by the vehicle-body-side link 91B pivoting on the basis of the opening and closing motions of the door 5. The timing generation unit 321 and the engagement and disengagement drive unit 322 are configured such that the hook lever 310 pivots when the hook cam 317 and the pressing protrusion 318 are engaged with and disengaged from each other on the basis of the relative displacement.

According to the configuration described above, it is possible to form the timing generation unit 321 and the engagement and disengagement drive unit 322 that operate autonomously on the basis of the motion of the joint link mechanism 100 that constitutes the coupling length variable mechanism 35. Thus, the coupling length L between the door 5 and the vehicle body 2 can be fixed or have the fixing released accurately by the operation of the coupling length fixing mechanism 300 at an appropriate timing based on the opening and closing motions of the door 5.

(5) The coupling length fixing mechanism 300 fixes the coupling length L at a timing when the engagement between the door-side engagement portion 31 and the vehicle-body-side engagement portion 32 is released on the basis of the opening motion of the door 5 moving from the fully closed position P0. Then, the coupling length fixing mechanism 300 releases the fixing of the coupling length L at a timing when the door-side engagement portion 31 and the vehicle-body-side engagement portion 32 are engaged with each other on the basis of the closing motion of the door 5 moving to the fully closed position P0.

According to the configuration described above, in a state where the door 5 is positioned in the vicinity of the fully closed position P0 where the door-side engagement portion 31 and the vehicle-body-side engagement portion 32 are engaged with each other, a change in the opening and closing motion track R based on the operation of the coupling length variable mechanism 35 is allowed. In a state where the door 5 is positioned on an open position of the opening and closing motions, where the engagement between the door-side engagement portion 31 and the vehicle-body-side engagement portion 32 is released, the coupling length L between the door 5 and the vehicle body 2 is fixed. Thus, the door 5 can be stably supported while securing smooth opening and closing motions of the door 5 in the vicinity of the fully closed position P0.

### Third Embodiment

Hereinafter, a third embodiment of a vehicle door apparatus will be described with reference to the drawings. Note that, for convenience of description, similar components to those in the first and second embodiments described above are denoted by the same reference signs, and description thereof is omitted.

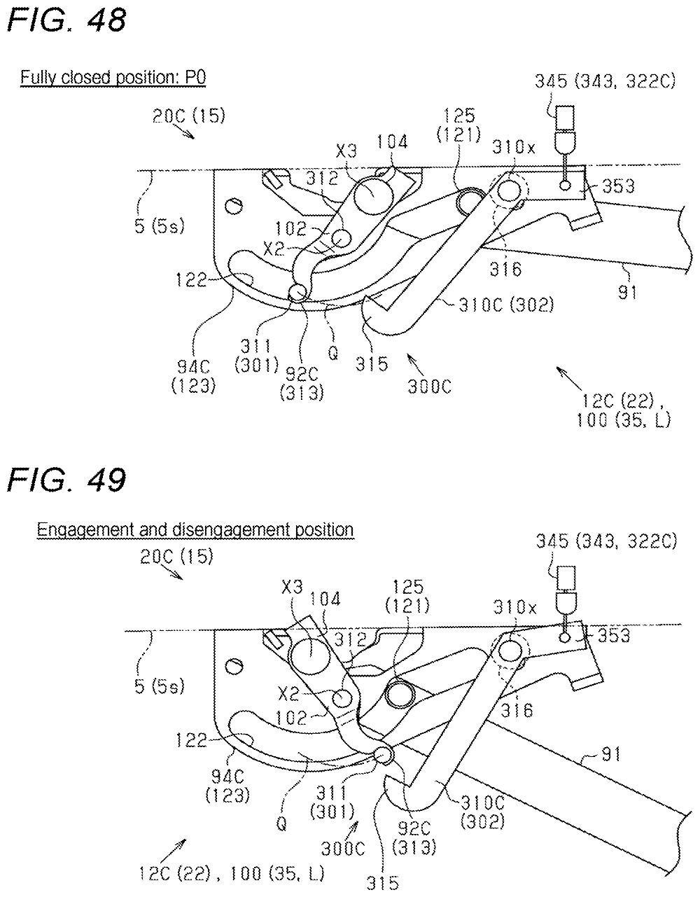

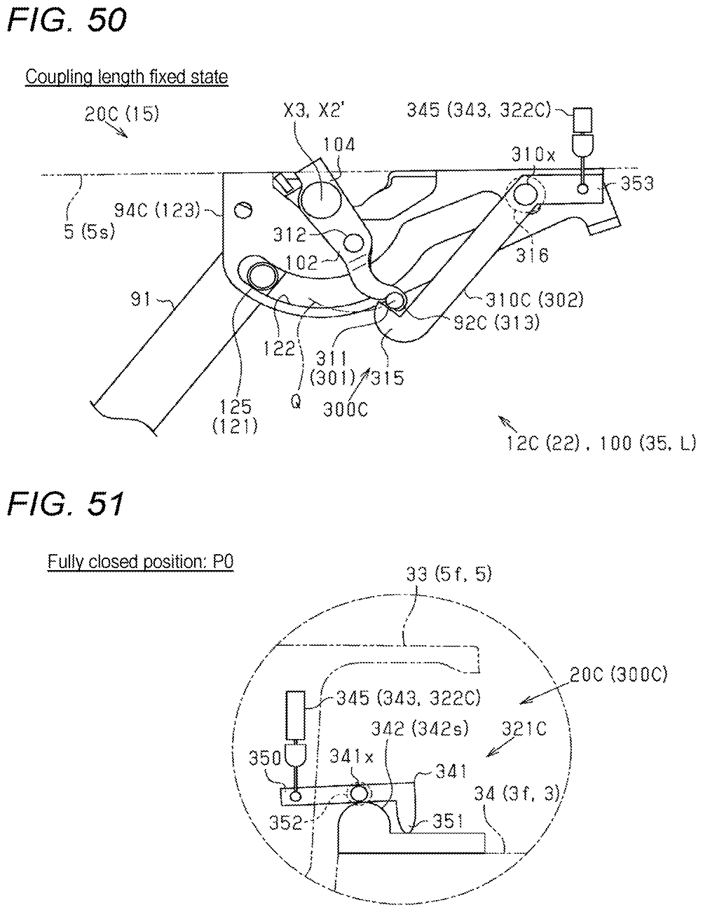

As shown in FIGS. 48 to 50, in comparison with the second embodiment described above, a vehicle door apparatus 20C of the present embodiment is different in the configuration of a coupling length fixing mechanism 300C, specifically, a configuration of a timing generation unit 321C and an engagement and disengagement drive unit 322C.

Specifically, in the vehicle door apparatus 20C of the present embodiment, a hook lever 310C of the coupling length fixing mechanism 300C does not include the hook cam 317 in the second embodiment described above (refer to FIGS. 44 to 46). Unlike the second embodiment described above, a roller 125 of an engagement protrusion 121 provided on a vehicle-body-side link 91 does not have a function as a pressing protrusion 318.

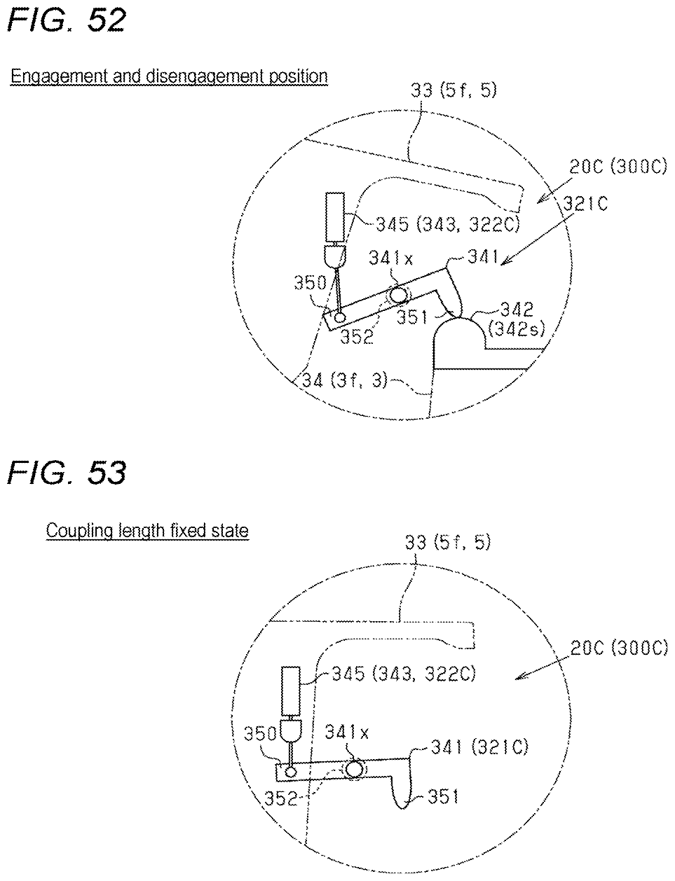

Furthermore, as shown in FIGS. 51 to 53, the vehicle door apparatus 20C of the present embodiment includes a door lever 341 provided on a closing-side end portion 33 of a door 5 and a vehicle-body cam 342 provided on a closing-side end portion 34 of a door opening portion 3. Note that, in FIGS. 51 to 53, the right side is a front side of a vehicle, and the left side is a rear side of the vehicle.

Moreover, as shown in FIGS. 48 to 53, the vehicle door apparatus 20C of the present embodiment includes a drive cable 345 which is a connection member 343 for connecting the door lever 341 and the hook lever 310C. The drive cable 345 has, for example, a known configuration in which a core material slides in a flexible resin tube so that drive force can be transmitted through the core material. The door lever 341, the vehicle-body cam 342, and the drive cable 345 form the timing generation unit 321C and the engagement and disengagement drive unit 322C.

As shown in FIGS. 51 to 53, the door lever 341 is pivotably supported by a support shaft 341x provided on the closing-side end portion 33 of the door 5. Furthermore, the door lever 341 has a connection portion 350 connected to the drive cable 345 on one end side in a longitudinal direction. The door lever 341 has an engagement portion 351 having a hook shape and provided on another end side in the longitudinal direction.

Meanwhile, the vehicle-body cam 342 has a cam surface 342s having a substantially arc-shaped cross section protruding from the closing-side end portion 34 of the door opening portion 3. When the closing-side end portion 33 of the door 5 comes into contact with and separates from the closing-side end portion 34 of the door opening portion 3 on the basis of the opening and closing motions of the door 5, the engagement portion 351 of the door lever 341 is engaged with and disengaged from the cam surface 342s of the vehicle-body cam 342. Thus, the door lever 341 pivots about the support shaft 341x.

Specifically, on the basis of the opening and closing motions of the door 5, the engagement portion 351 of the door lever 341 is engaged with the cam surface 342s of the vehicle-body cam 342 in such a manner as to run on the cam surface 342s. Similarly to the hook lever 310C, the door lever 341 is pivotally biased in a direction in which the engagement portion 351 is pressed against the cam surface 342s of the vehicle-body cam 342 on the basis of elastic force of a torsion coil spring 352 disposed about the support shaft 341x. When the engagement portion 351 passes a position at which the engagement portion 351 is engaged with the cam surface 342s of the vehicle-body cam 342, the door lever 341 pivots about the support shaft 341x.

That is, when the engagement portion 351 is engaged with the cam surface 342s of the vehicle-body cam 342, the door lever 341 pivots against a biasing force of the torsion coil spring 352, counterclockwise in each drawing. Then, when the engagement portion 351 is disengaged from the cam surface 342s of the vehicle-body cam 342, the door lever 341 pivots on the basis of the biasing force of the torsion coil spring 352, clockwise in each drawing.

The vehicle door apparatus 20C is configured such that the engagement portion 351 of the door lever 341 and the cam surface 342s of the vehicle-body cam 342 are disengaged from each other in a case where the door 5 is at a fully closed position P0. The door lever 341 is engaged with and disengaged from the vehicle-body cam 342 on the basis of an opening motion of the door 5 moving from the fully closed position P0. The door lever 341 is engaged with and disengaged from the vehicle-body cam 342 also during the closing motion of the door 5 moving to the fully closed position P0.

As shown in FIGS. 48 to 53, the pivoting of the door lever 341 associated with the engagement and disengagement with respect to the vehicle-body cam 342 is transmitted to the hook lever 310C via the drive cable 345. The hook lever 310C has a connection portion 353 for the drive cable 345 at an end portion in the longitudinal direction opposite to an end portion provided with the engagement portion 315. When the hook lever 310C pivots, similarly to the hook lever 310 in the first embodiment described above, the engagement portion 315 is engaged with and disengaged from the engagement protrusion 311 provided on a door-side link 92C. The door-side link 92C and the door 5 are fixed or have the fixing released by engagement and disengagement between the engagement protrusion 311, which is the first engagement member 301, and the hook lever 310C, which is the second engagement member 302. That is, the coupling length L between the door 5 and the vehicle body 2 is fixed or has the fixing released.

In this manner, in the vehicle door apparatus 20C of the present embodiment, the door lever 341 and the vehicle-body cam 342 are engaged with and disengaged from each other on the basis of the opening and closing motions of the door 5, by which the timing generation unit 321C is formed. The motion of the door lever 341 is transmitted to the hook lever 310C via the drive cable 345, by which the engagement and disengagement drive unit 322C is formed.

Engagement and disengagement timings of the engagement protrusion 311 and the hook lever 310C are set in accordance with engagement and disengagement timings of the door-side engagement portion 31 and the vehicle-body-side engagement portion 32 (refer to FIG. 47). Thus, in a state where the door 5 is positioned in the vicinity of the fully closed position P0 where the door-side engagement portion 31 and the vehicle-body-side engagement portion 32 are engaged with each other, fixing of the coupling length L is released.

As described above, effects as those obtained in the second embodiment can also be obtained with the configuration according to the present embodiment. Furthermore, in the vehicle door apparatus 20C of the present embodiment, the timing generation unit 321C has a configuration independent of the engagement protrusion 311, which is the first engagement member 301, and the hook lever 310C, which is the second engagement member 302. Therefore, the engagement and disengagement timings can be easily adjusted. Moreover, the engagement and disengagement drive unit 322C is formed by connecting, via the drive cable 345 that is the connection member 343, the door lever 341 and the hook lever 310C that constitute the timing generation unit 321C. Thus, with a simple configuration, the hook lever 310C can be accurately engaged with and disengaged from the engagement protrusion 311, and high reliability for the apparatus can be ensured.

### Fourth Embodiment

Hereinafter, a fourth embodiment of a vehicle door apparatus will be described with reference to the drawings. Note that, for convenience of description, similar components to those in the first embodiment described above are denoted by the same reference signs, and description thereof is omitted.

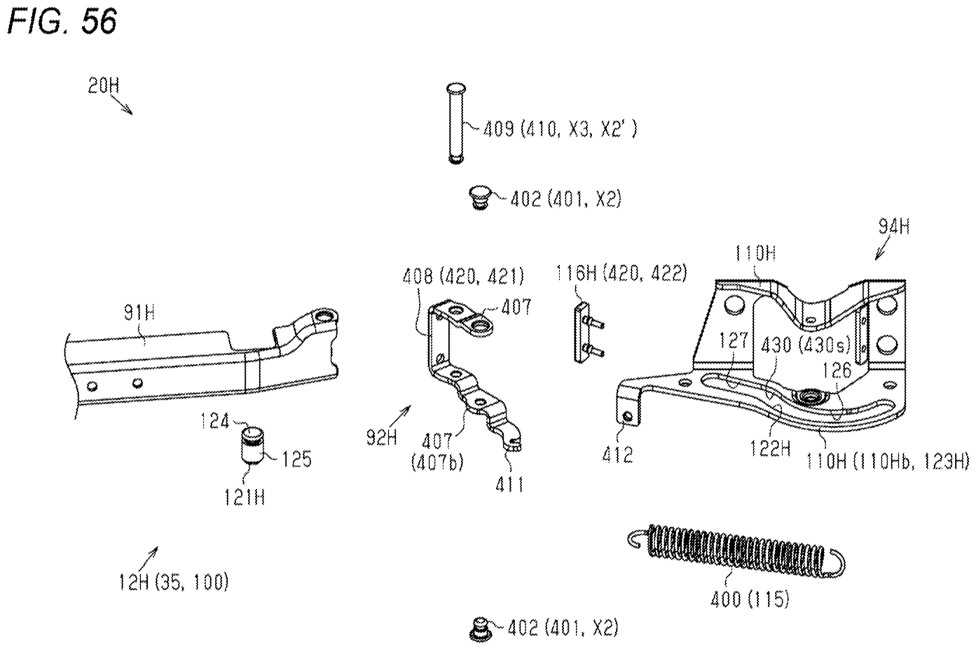

As shown in FIGS. 55 to 57, in comparison with the first embodiment described above, a vehicle door apparatus 20H of the present embodiment is different in a configuration of a door bracket 94H to which a second link arm 12H is coupled.

More specifically, also in the vehicle door apparatus 20H of the present embodiment, the second link arm 12H includes a vehicle-body-side link 91H and a door-side link 92H relatively pivotably coupled to each other. The door bracket 94H also includes a pair of coupling walls 110H, 110H facing each other in an up-down direction. The door-side link 92H is pivotably coupled to both the coupling walls 110H, 110H.

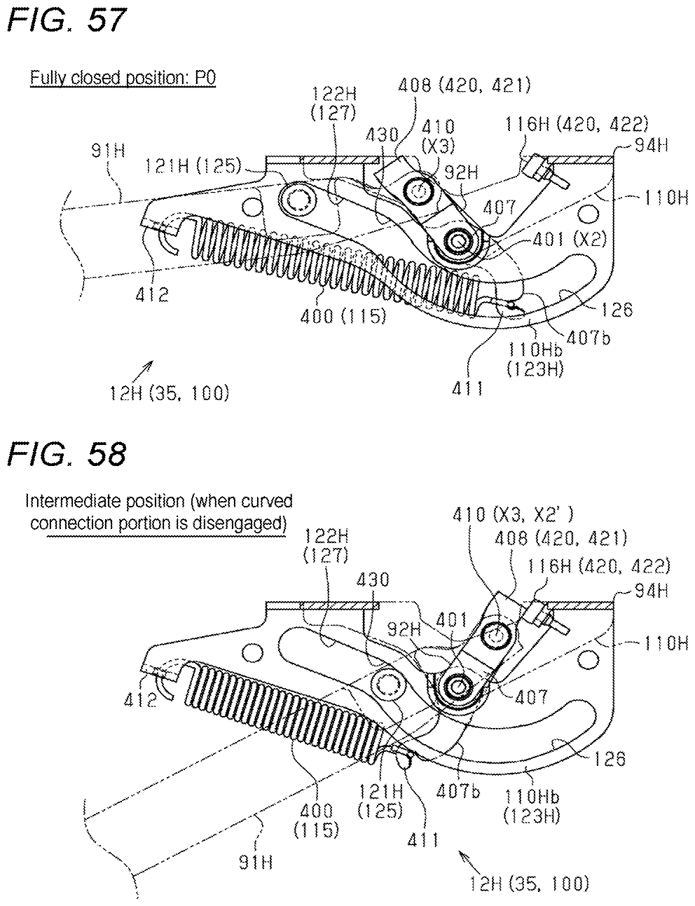

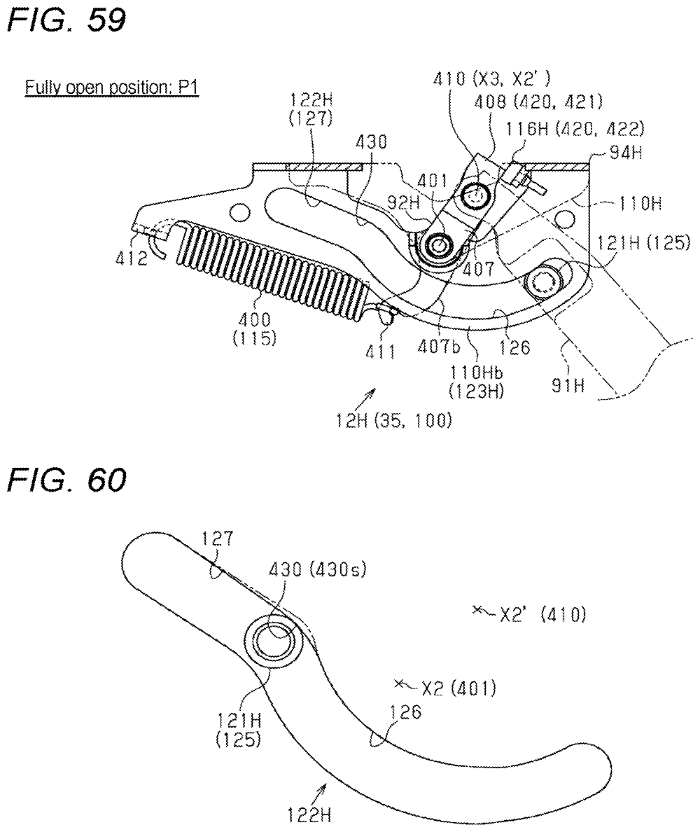

As shown in FIGS. 57 to 59, coupling of the door-side link 92H to the door bracket 94H forms a second pivot coupling point X2 with respect to the door 5. As in the first embodiment described above, a coupling length L between the door 5 and a vehicle body 2 by the second link arm 12H changes on the basis of relative pivoting of the vehicle-body-side link 91H and the door-side link 92H (refer to FIGS. 22 and 23). That is, a joint link mechanism 100 formed by the vehicle-body-side link 91H and the door-side link 92H constitutes a coupling length variable mechanism 35.

Furthermore, as shown in FIGS. 55 to 57, in the door bracket 94H of the present embodiment, a cam member 123H is provided integrally with a lower coupling wall 110Hb of both the coupling walls 110H, 110H facing each other in the up-down direction. An engagement protrusion 121H provided on the vehicle-body-side link 91H protrudes downward from the vehicle-body-side link 91H and engages with a cam groove 122H provided on the cam member 123H.

In the vehicle door apparatus 20H of the present embodiment, an extension coil spring 400 is used for a biasing member 115 of the door-side link 92H. The door-side link 92H is pivotally biased about a pivot shaft 401 on the basis of a tensile force of the extension coil spring 400. Thus, the vehicle-body-side link 91H and the door-side link 92H that constitute the coupling length variable mechanism 35 are caused to relatively pivot in a direction in which a coupling length L between first and second pivot coupling points X1, X2 is shortened.

The door-side link 92H is a plate-like member bent in a substantially U shape and having a pair of coupling portions 407, 407 disposed to face both the coupling walls 110H, 110H of the door bracket 94H and a connection portion 408 connecting both the coupling portions 407, 407. Both the respective coupling portions 407, 407 are pivotably coupled to the corresponding coupling walls 110H, 110H of the door bracket 94H via corresponding coupling pins 402, 402.

The vehicle door apparatus 20H includes a shaft-shaped member 409 provided on the door-side link 92H in such a manner as to be bridged between both the coupling portions 407, 407 at a position in a vicinity of the connection portion 408. The shaft-shaped member 409 constitutes a coupling shaft 410 coupling the vehicle-body-side link 91H to the door-side link 92H. The vehicle-body-side link 91H and the door-side link 92H are relatively pivotable about the coupling shaft 410 in a state where the vehicle-body-side link 91H is sandwiched between both the coupling portions 407, 407 of the door-side link 92H.

The door-side link 92H includes a spring locking portion 411 provided on a lower coupling portion 407b of both the coupling portions 407, 407. The spring locking portion 411 extends from a tip end of the lower coupling portion 407b. The spring locking portion 411 is provided on an opposite side of the connection portion 408 with respect to a coupling pin 402. The lower coupling wall 110Hb of the door bracket 94H is provided with a spring locking portion 412 paired with the spring locking portion 411 of the door-side link 92H. The spring locking portion 412 is provided on an end portion on a rear side (left side in FIG. 57) of the door bracket 94H, that is, at an end portion of the door bracket 94H in a direction in which the second link arm 12H extends in a case where the door 5 is in a fully closed state. Both ends of the extension coil spring 400 are locked to both the spring locking portions 411, 412.

In a case where the door 5 is in the fully closed state, the spring locking portion 411 of the door-side link 92H is disposed on a front side (right side in FIG. 57) of the pivot shaft 401. On the basis of elastic force of the extension coil spring 400 locked to the spring locking portion 411, the door-side link 92H is pivotally biased about the pivot shaft 401 clockwise in FIG. 57. Thus, an angle formed by the vehicle-body-side link 91H and the door-side link 92H that constitute the joint link mechanism 100 is narrowed. That is, the door-side link 92H is biased such that the vehicle-body-side link 91H and the door-side link 92H relatively pivot in a direction in which the coupling length L between the first and second pivot coupling points X1, X2 is shortened.

The lower coupling portion 407b of the door-side link 92H, that is, the coupling portion 407b having the spring locking portion 411 is disposed below the lower coupling wall 110Hb of the door bracket 94H. The spring locking portion 412 provided on the coupling wall 110Hb extends downward from the coupling wall 110Hb. Thus, the extension coil spring 400 locked to both the spring locking portions 411, 412 does not interfere with the door bracket 94H.

As shown in FIGS. 57 to 59, when the door 5 performs an opening motion from a fully closed position P0, the connection portion 408 of the door-side link 92H abuts on a stopper 116H of the door bracket 94H on the basis of operation of the coupling length variable mechanism 35. That is, the connection portion 408 of the door-side link 92H abuts on the stopper 116H of the door bracket 94H in synchronization with a timing at which engagement between the door-side engagement portion 31 and the vehicle-body-side engagement portion 32 is released (refer to FIG. 7). On the basis of a function of a stopper mechanism 420 formed by the connection portion 408 and the stopper 116H, a stable opening and closing motion posture of the door 5 is ensured.

The stopper 116H and the connection portion 408 of the door-side link 92H come into contact with and separate from each other on the basis of the operation of the coupling length variable mechanism 35. When the connection portion 408 of the door-side link 92H abuts on the stopper 116H of the door bracket 94H, pivoting of the door-side link 92H clockwise with respect to the door bracket 94H is restricted. The connection portion 408 of the door-side link 92H and the stopper 116H of the door bracket 94H are first and second abutting portions 421, 422 that constitute the stopper mechanism 420.

on the basis of a biasing force of the biasing member 115, a state in which the first and second abutting portions 421, 422 abut on each other is maintained. Thus, a change in the coupling length L based on the operation of the coupling length variable mechanism 35 is restricted.

In a configuration in which the vehicle-body-side link 91H and the door-side link 92H relatively pivotably coupled to each other form the coupling length variable mechanism 35, the door-side link 92H is integrated with the door 5 by the door-side link 92H being pressed against the stopper 116H on the basis of the biasing force of the biasing member 115. Furthermore, the door 5 performs the opening and closing motions while the vehicle-body-side link 91H relatively pivots about an intermediate coupling point X3 with respect to the door-side link 92H.

That is, the intermediate coupling point X3 is a new second pivot coupling point X2′ with respect to the door 5. In other words, the second pivot coupling point X2 with respect to the door 5 transitions. Thus, the coupling length L between the first and second pivot coupling points X1, X2 is fixed to a constant value based on a length of the vehicle-body-side link 91H.

### (Structure of Mitigating Impact of Abutting Stopper)

As shown in FIG. 60, as in the first embodiment described above, the cam groove 122H provided on the cam member 123H has an arc-shaped portion 126 and a linear portion 127. The cam groove 122H also has a curved connection portion 430 having a curved shape and connecting the arc-shaped portion 126 and the linear portion 127.

When the engagement protrusion 121H in the cam groove 122H moves from the linear portion 127 to the arc-shaped portion 126, the movement of the engagement protrusion 121H is guided by the engagement protrusion 121H coming into sliding contact with the curved connection portion 430. Thus, an impact generated when the first and second abutting portions 421, 422 that configure the stopper mechanism 420 abut on each other is mitigated.

As shown in FIGS. 57 to 59, when the door 5 performs the opening motion from the fully closed position P0, the connection portion 408 of the door-side link 92H abuts on the stopper 116H of the door bracket 94H. Thus, a change in the coupling length L based on the operation of the coupling length variable mechanism 35 is restricted, by which an opening and closing motion track R of the door 5 changes from a linear-shaped slide track Rs to an arc-shaped glide track Rg (refer to FIG. 4). In the cam groove 122H provided on the cam member 123H, the arc-shaped portion 126 corresponds to the glide track Rg, and the linear portion 127 corresponds to the slide track Rs.

The engagement protrusion 121H in the linear portion 127 moves toward the arc-shaped portion 126 in conjunction with a motion of the connection portion 408 of the door-side link 92H approaching the stopper 116H of the door bracket 94H on the basis of the operation of the coupling length variable mechanism 35. When the connection portion 408 abuts on the stopper 116H, the engagement protrusion 121H moves in the arc-shaped portion 126 in a state where the change in the coupling length L based on the operation of the coupling length variable mechanism 35 is restricted.

When the opening and closing motion track R is switched from the slide track Rs to the glide track R as described above, the connection portion 408 of the door-side link 92H swiftly abuts on the stopper 116H, which may cause shaking and vibration of the door 5.

Based on this point, in the vehicle door apparatus 20H of the present embodiment, the curved connection portion 430 provided between the linear portion 127 and the arc-shaped portion 126 guides movement of the engagement protrusion 121H from the linear portion 127 toward the arc-shaped portion 126.

Specifically, as shown in FIG. 60, a side wall 430s of the curved connection portion 430 in sliding contact with the engagement protrusion 121 directing from the linear portion 127 toward the arc-shaped portion 126 is formed to have a gentle arc shape. Thus, a large curvature radius is imparted to the side wall 430s of the curved connection portion 430. A dash-dot-dot line in FIG. 60 indicates a shape of a connection portion between the linear portion 127 and the arc-shaped portion 126 in a case where such a curved connection portion 430 is not provided.

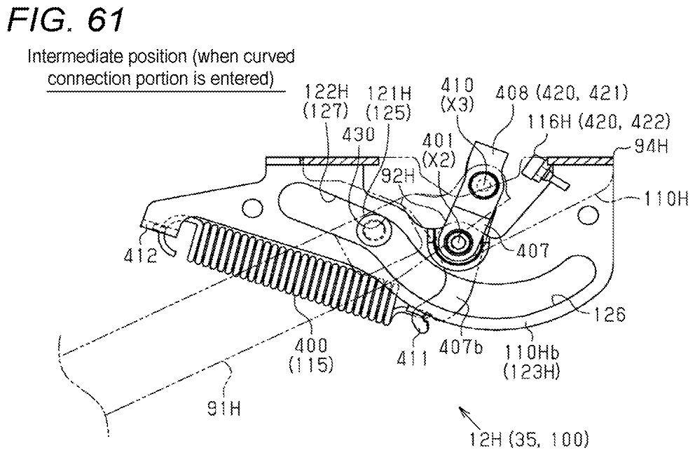

As shown in FIGS. 58 and 61, when the engagement protrusion 121 directed from the linear portion 127 to the arc-shaped portion 126 enters the curved connection portion 430, the connection portion 408 of the door-side link 92H does not yet abut on the stopper 116H (refer to FIG. 61). The engagement protrusion 121 that has entered the curved connection portion 430 moves inside the curved connection portion 430 while being in sliding contact with the side wall 430s of the curved connection portion 430. When the engagement protrusion 121 is disengaged from the curved connection portion 430, the connection portion 408 of the door-side link 92H is in contact with the stopper 116H (refer to FIG. 58).

In this manner, the connection portion 408 of the door-side link 92H abuts on the stopper 116H in a state where the engagement protrusion 121 moving in the cam groove 122H is guided by the curved connection portion 430. At this time, the connection portion 408 of the door-side link 92H gently abuts on the stopper 116H on the basis of the curved shape of the curved connection portion 430.

As described above, effects as those obtained in the first embodiment can also be obtained with the configuration according to the present embodiment. Moreover, at the time of the opening motion of the door 5 from the fully closed position P0, it is possible to mitigate an impact generated when the connection portion 408 of the door-side link 92H abuts on the stopper 116H. Thus, shaking and vibration of the door 5 can be reduced, by which highly-qualified operation of the door 5 can be ensured.

Note that each of the embodiments described above can be modified as follows. Each of the embodiments described above and the following modifications can be implemented in combination within a range not technically contradictory.
In each of the embodiments described above, the coupling length variable mechanism 35 includes the joint link mechanism 100 formed by pivotably coupling the vehicle-body-side link 91 having the first pivot coupling point X1 and the door-side link 92 having the second pivot coupling point X2. However, the present disclosure is not limited thereto, and a configuration of the coupling length variable mechanism 35 may be arbitrarily changed.

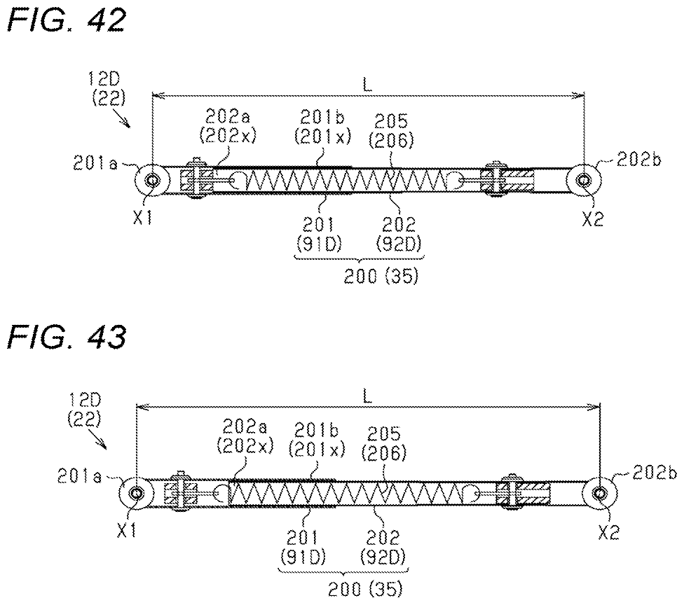

For example, the coupling length variable mechanism 35 including an extensible link mechanism 200 of linearly moving type as shown in FIGS. 42 and 43 may be provided on a second link arm 12D. The second link arm 12D shown in this another example includes an outer tube 201 and an inner tube 202 concentrically disposed. The outer tube 201 includes a first end portion 201a having the first pivot coupling point X1 with respect to the vehicle body 2 and a second end portion 201b having an opening portion 201x. The inner tube 202 includes a second end portion 202b having the second pivot coupling point X2 with respect to the door 5 and a first end portion 202a having an opening portion 202x. An inner diameter of the outer tube 201 is larger than an outer diameter of the inner tube 202. By inserting the first end portion 202a of the inner tube 202 into the outer tube 201 from the opening portion 201x of the outer tube 201, the outer tube 201 and the inner tube 202 are concentrically disposed.

In the second link arm 12D shown in this another example, the outer tube 201 constitutes a vehicle-body-side link 91D, and the inner tube 202 constitutes a door-side link 92D. When the outer tube 201 and the inner tube 202 are relatively displaced in an axial direction, the coupling length L between the first and second pivot coupling points X1, X2 changes.

Specifically, the coupling length L between the first and second pivot coupling points X1, X2 is extended by the inner tube 202 being pulled out of the outer tube 201. When the inner tube 202 is embedded in the outer tube 201, the coupling length L between the first and second pivot coupling points X1, X2 is shortened.

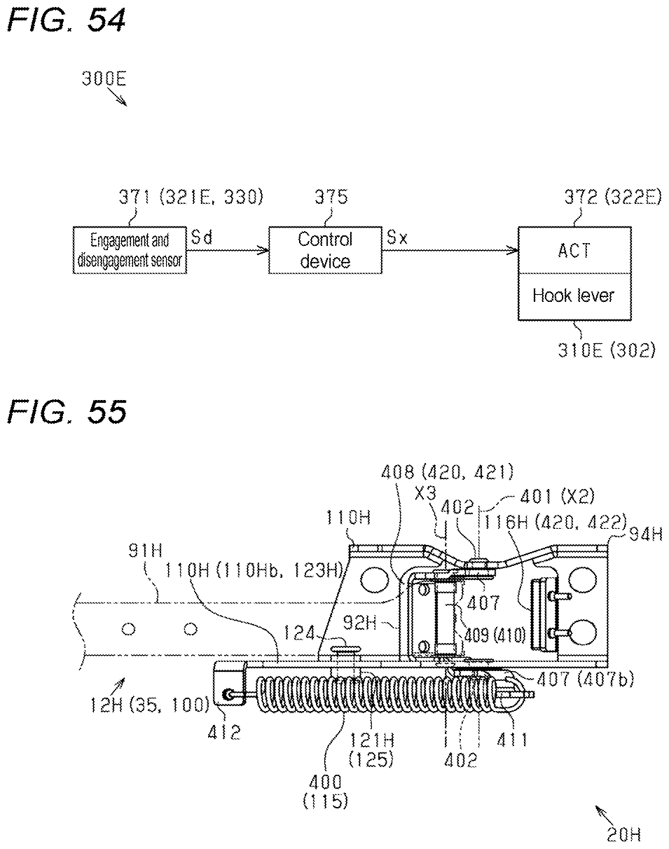

The second link arm 12D shown in this another example is provided with a biasing member 205 that applies a tensile force in a direction of shortening the coupling length L between the first and second pivot coupling points X1, X2. For the biasing member 205, for example, an extension spring 206 can be used. The coupling length L between the first and second pivot coupling points X1, X2 is maintained during the opening and closing motions of the door 5 by utilizing the biasing force F generated by the biasing member 205. Effects as those obtained in each of the embodiments described above can also be obtained by adopting such a configuration.
In the another example described above, the outer tube 201 and inner tube 202 that are long and concentrically disposed so as to form the extensible link mechanism 200 constitute the vehicle-body-side link 91D and the door-side link 92D. However, the present disclosure is not limited thereto, and the vehicle-body-side link 91D and the door-side link 92D do not necessarily have a form of two concentrically disposed tubes. As long as the vehicle-body-side link 91D and the door-side link 92D are disposed so as to be relatively displaceable along the axial direction, shapes of the links 91D and 92D may be arbitrarily changed.
In each of the embodiments described above, the first link arm 11 having a configuration as the main link 21 is disposed above the second link arm 12 having a configuration as the sub link 22. Then, the second link arm 12 is disposed at a position closer to the closing-side end portion 33 of the door 5 than the first link arm 11 is. However, the present disclosure is not limited thereto, and the disposition of the first and second link arms 11, 12 may be arbitrarily changed.
In each of the embodiments described above, the coupling length variable mechanism 35 is provided on the second link arm 12, but the coupling length variable mechanism 35 may be provided on the first link arm 11. Furthermore, the coupling length variable mechanism 35 may be provided on both the first and second link arms 11, 12. Then, depending on the disposition of the first and second link arms 11, 12 and the coupling length variable mechanism 35, the coupling length variable mechanism 35 may be configured so as to reduce or increase the coupling length L between the first and second pivot coupling points X1, X2 when the door 5 performs the closing motion to the fully closed position P0.
The biasing members 115, 205 of the coupling length variable mechanism 35 may be arbitrarily changed. For example, another elastic member such as a compression spring, or a biasing member of gas-type, electromagnetic-type, or the like may be used. Furthermore, depending on the disposition of the coupling length variable mechanism 35, the biasing member may be configured to generate a biasing force in a direction of extending the coupling length L between the first and second pivot coupling points X1, X2. The coupling length variable mechanism 35 may not be provided with a biasing member.
In each of the embodiments described above, the actuator 25 drives the first link arm 11, but the actuator 25 may drive the second link arm 12. Furthermore, one or more actuators 25 may drive both the first and second link arms 11, 12. That is, the number and disposition of the actuators 25 may be arbitrarily changed. Furthermore, for example, the actuator 25 may be provided on the door 5. The actuator 25 may be incorporated in a link arm. The configuration of the actuator 25 may also be arbitrarily changed.
In each of the embodiments described above, the door 5 of the vehicle 1 performs the opening motion toward the rear side, but the door 5 may perform the opening motion toward the front side. The vehicle door apparatus may be a manual door apparatus having no drive source such as the actuator 25.
In each of the embodiments described above, the shaft-shaped engagement portion 41 is formed by the roller 48 supported by the support shaft 47, but the shaft-shaped engagement portion 41 is not necessarily rotatable. The engagement portion 41 does not necessarily have to have a shaft shape, and may have any shape as long as the portion functions as a guide engagement portion that guides the opening and closing motions of the door 5 while being disposed in the guide groove 42.
In each of the embodiments described above, the door-side engagement portion 31 has the shaft-shaped engagement portion 41, and the vehicle-body-side engagement portion 32 has the guide groove 42. However, the present disclosure is not limited thereto, and the door-side engagement portion 31 may have the guide groove 42, and the vehicle-body-side engagement portion 32 may have the shaft-shaped engagement portion 41.
The number and disposition of the door-side engagement portions 31 and the vehicle-body-side engagement portions 32 may be arbitrarily changed. The shape and fixing structure of the guide member 50 forming the guide groove 42 may be arbitrarily changed. For example, the guide member 50 may be directly fixed to the installation surface 52 without using the fixing bracket 53. The guide member 50 may not include the buffer member 80. The first and second guide members 71, 72 may have the same configuration.
In each of the embodiments described above, the door-side link 92 is shorter than the vehicle-body-side link 91. However, lengths of the vehicle-body-side link 91 and the door-side link 92 may be arbitrarily changed. For example, the door-side link 92 may be longer than the vehicle-body-side link 91.
The shapes of the respective vehicle-body-side link 91 and the shape of the door-side link 92 may be arbitrarily changed. For example, the door-side link 92 may have a shaft-like outer shape similarly to the vehicle-body-side link 91. The vehicle-body-side link 91 may not include, for example, the bent-shaped portion 106 that is formed like a crank. The vehicle-body-side link 91 may have an outer shape such as a plate shape or a frame shape.
In each of the embodiments described above, the cam member 123 is provided integrally with the door bracket 94, but the cam member 123 may be provided on the door 5 independently of the door bracket 94.
In each of the embodiments described above, the engagement protrusion 121 is provided on the second link arm 12 including the coupling length variable mechanism 35. However, the present disclosure is not limited thereto, and in a case where the coupling length variable mechanism 35 is provided on the first link arm 11 as in the another example described above, the engagement protrusion 121 may be provided on the first link arm 11. In a case where the coupling length variable mechanism 35 is provided on both the first and second link arms 11, 12, the engagement protrusion 121 may be provided on both the link arms 11, 12.
In each of the embodiments described above, the engagement protrusion 121 is provided with the roller 125 in sliding contact with the cam groove 122. However, the present disclosure is not limited thereto, and a shape of the engagement protrusion 121 may be arbitrarily changed such that the engagement protrusion 121 is, for example, a shaft-shaped member without the roller 125.
In each of the embodiments described above, the engagement protrusion 121 is provided on the vehicle-body-side link 91, but the engagement protrusion 121 may be provided on the door-side link 92.
The cam member 123 may be provided on the vehicle body 2. Such a configuration may be adopted, for example, in a case where the vehicle-body-side link 91 is shorter than the door-side link 92 as in the another example described above. A similar applies to a case where the coupling length variable mechanism 35 includes the extensible link mechanism 200 as in the another example described above.
In each of the embodiments described above, the buffer member 131 provided on the second link arm 12 is sandwiched between the second link arm 12 and the vehicle body 2 in a case where the door 5 is at the fully open position P1. However, the present disclosure is not limited thereto, and the buffer member 131 provided on the vehicle body 2 may be sandwiched between the second link arm 12 and the vehicle body 2 by the second link arm 12 pivoting. Furthermore, the buffer member 131 may be disposed so as to be sandwiched between the first link arm 11 and the vehicle body 2 in a case where the door 5 is at the fully open position P1. In this case, the buffer member 131 may be provided on the first link arm 11 or may be provided on the vehicle body 2. There may be provided both the buffer member 131 sandwiched between the first link arm 11 and the vehicle body 2, and the buffer member 131 sandwiched between the second link arm 12 and the vehicle body 2.
In each of the embodiments described above, the first pivot coupling point X1 of the second link arm 12 is formed by fitting the cylindrical buffer member 137 into the through hole 135 provided in the plate-shaped coupling portion 136 and inserting the support shaft 133 into the cylindrical buffer member 137. The intermediate coupling point X3 of the second link arm 12 and the first pivot coupling point X1 of the first link arm 11 also have a similar pivot coupling structure. However, the present disclosure is not limited thereto, and the second pivot coupling points X2, X2 of the respective first and second link arms 11, 12 may also have the similar pivot coupling structure. Setting portions for such pivot coupling structures may be arbitrarily changed. That is, at least one of the pivot coupling points of the first and second link arms 11, 12 preferably has such a pivot coupling structure. Thus, by increasing flexibility of coupling, it is possible to absorb a manufacturing tolerance, an assembly tolerance, or the like to improve assemblability.
In each of the embodiments described above, the friction member 175 is disposed between the first and second pivot coupling portions 171, 172 forming the second pivot coupling point X2 of the first link arm 11. However, the present disclosure is not limited thereto, and such a sliding resistance applying structure using the friction member 175 may be provided for the second pivot coupling point X2 of the second link arm 12. Similarly, the sliding resistance applying structure using the friction member 175 may be provided for the first pivot coupling points X1, X1 of the first and second link arms 11, 12, and the intermediate coupling point X3 of the joint link mechanism 100. Such a sliding resistance applying structure may be provided on an arbitrary pivot coupling point. That is, at least one of the pivot coupling points of the first and second link arms 11, 12 preferably has such a pivot coupling structure. Thus, the shaking and vibration generated in the door 5 are attenuated, by which the opening and closing motion posture of the door 5 can be stably maintained.
In each of the embodiments described above, the friction member 175 is formed by using a resin material, but the material of the friction member 175 may be arbitrarily changed. For example, the friction member 175 may be formed by using a metal material. Whether or not to treat a surface of the friction member 175 for increasing frictional resistance thereof is also arbitrary.
In each of the embodiments described above, the first link arm 11 includes the pair of pipe frames 151, 151 arranged in the up-down direction, and the base end portions and tip end portions of both the pipe frames 151, 151 are connected by the base end bracket 153 and the tip end bracket 154, respectively. However, the present disclosure is not limited thereto, and the configuration of the first link arm 11 may be arbitrarily changed.
In the second and third embodiments described above, the engagement protrusion 311 provided on the door-side links 92B and 92C constitutes the first engagement member 301. The hook lever 310, 310C provided on the door bracket 94B constitutes the second engagement member 302. However, the present disclosure is not limited thereto, and a configuration of the first engagement member 301 and the second engagement member 302 may be changed to any configuration as long as the coupling length L can be fixed on the basis of mutual engagement force. For example, a pivotal lever member such as the hook lever 310 may not be necessarily used, and a lever member of linearly moving type, or the like may be used. Moreover, for example, the configurations of the first engagement member 301 and the second engagement member 302 may be exchanged by providing the engagement protrusion 311 on the door 5 and providing the hook lever 310 on the door-side link 92B. Engagement shapes and modes of engagement and disengagement of the first engagement member 301 and the second engagement member 302 may also be arbitrarily changed.
In the second and third embodiments described above, the coupling length fixing mechanism 300, 300C fixes the coupling length L by restricting the relative pivoting of the door-side link 92B, 92C with respect to the door 5. However, the present disclosure is not limited thereto, and the coupling length L between the first and second pivot coupling points X1, X2 may be fixed by fixing an included angle between the vehicle-body-side link 91 and the door-side link 92 that are pivotably coupled.
The coupling length fixing mechanism 300 may be applied to a configuration in which the extensible link mechanism 200 of linearly moving type as in the another example described above is used for the coupling length variable mechanism 35. In this case, the coupling length L between the first and second pivot coupling points X1, X2 can be fixed by restricting the relative displacement, in the axial direction, of the outer tube 201 and inner tube 202 that constitute the extensible link mechanism 200. Effects as those obtained in the second and third embodiments described above can also be obtained by adopting such a configuration.
For example, a coupling length fixing mechanism 300E shown in FIG. 54 includes an engagement and disengagement sensor 371 that detects an engagement and disengagement state of the door-side engagement portion 31 and the vehicle-body-side engagement portion 32, and an actuator 372 that has a drive source such as a motor and drives a hook lever 310E. The engagement and disengagement sensor 371 constitutes a timing generation unit 321E, and the actuator 372 constitutes an engagement and disengagement drive unit 322E. Engagement and disengagement timings generated by the timing generation unit 321E are transmitted to the engagement and disengagement drive unit 322E as an electric signal. By adopting such a configuration, flexibility of design can be improved.

In this example, an engagement and disengagement detection signal Sd output from the engagement and disengagement sensor 371 is input to a control device 375. The control device 375 outputs a control signal Sx to the actuator 372 on the basis of the engagement and disengagement detection signal Sd. However, the present disclosure is not limited thereto, and the coupling length fixing mechanism 300E may not include the control device 375. In this case, the actuator 372 directly operates on the basis of the engagement and disengagement detection signal Sd output from the engagement and disengagement sensor 371. The drive source of the actuator 372 may be a solenoid or the like other than the motor, and may be arbitrarily changed.
In the second and third embodiments described above, fixing of and release of the fixing of the coupling length L by operation of the coupling length fixing mechanism 300 are executed in accordance with the engagement and disengagement timings of the door-side engagement portion 31 and the vehicle-body-side engagement portion 32 that constitute the guide mechanism 330. However, the present disclosure is not limited thereto, and the timing of fixing of and release of the fixing of the coupling length L may be arbitrarily set, and may not be synchronized with the opening and closing motions of the door 5, for example.
The biasing member 115 that pivotally biases the vehicle-body-side link 91 and the door-side link 92 about the intermediate coupling point X3 as in the first and fourth embodiments described above, and the coupling length fixing mechanism 300, 300C as in the second and third embodiments described above may be used in combination.
In each of the embodiments described above, the opening and closing motion track R of the door 5 based on the operation of the coupling length variable mechanism 35 is expressed as the “arc-shaped glide track Rg” or the “linear-shaped slide track Rs”, but such arc-shaped track and linear-shaped track may be referred to arbitrarily.
The arc-shaped track is not necessarily a track along a perfect circle, and the linear-shaped track is not necessarily a track along a perfect straight line. For example, the linear-shaped track (slide track Rs) in each of the embodiments described above indicates a track of the door 5 sliding along the opening width direction of the door opening portion 3 or the front-rear direction of the vehicle, specifically, the track of the closing-side end portion 33.
In the fourth embodiment described above, the connection portion 408 of the door-side link 92H and the stopper 116H of the door bracket 94H correspond to the first and second abutting portions 421, 422 that constitute the stopper mechanism 420. However, the present disclosure is not limited thereto, and a configuration of the stopper mechanism 420 may be arbitrarily changed. For example, a portion of the door-side link 92H, the portion abutting on the stopper 116H, is not necessarily the connection portion 408.
Disposition the first and second abutting portions 421, 422 may be arbitrarily set as long as the change in the coupling length L can be restricted by the first and second abutting portions 421, 422 abutting on each other. For example, the vehicle-body-side link 91H and the door-side link 92H may be provided with the first and second abutting portions 421, 422. In this case, a change in an included angle between the vehicle-body-side link 91H and the door-side link 92H is restricted by the first and second abutting portions 421, 422 abutting on each other. Thus, the coupling length L between the first and second pivot coupling points X1, X2 is maintained constant.
In a configuration in which the extensible link mechanism 200 of linearly moving type is used for the coupling length variable mechanism 35 as in the another example described above, a configuration may be adopted in which the cam groove 122H has the curved connection portion 430 connecting the arc-shaped portion 126 and the linear portion 127. Also in this case, the configuration of the stopper mechanism 420 may be arbitrarily changed.
A configuration of the coupling point formation portion 180 forming the first pivot coupling point X1 may be arbitrarily changed. For example, a shape of the base end bracket 153 that constitutes the base end portion 11a of the first link arm 11 and a shape of the vehicle-body bracket 155 provided on the vehicle body 2 may be arbitrarily changed. For example, the first pivot coupling point X1 does not necessarily have the upper coupling point 181 and the lower coupling point 182 that are separated from each other in the up-down direction. A configuration and fixing structure of the actuator 25 may also be arbitrarily changed. The actuator 25 may be disposed outside the coupling point formation portion 180, for example, below or above the coupling point formation portion 180. However, from a viewpoint of implementing a compact apparatus, it is preferable to dispose the actuator 25 in the coupling point formation portion 180
The actuator 25 is not necessarily held on the vehicle body 2, and for example, the actuator 25 may be held on the base end portion 11a of the first link arm 11. The actuator 25 may be held on the door 5. The actuator 25 may be held on the tip end portion 11b of the first link arm 11.
The first link arm 11 may be provided with the coupling length variable mechanism 35, and the drive force of the actuator 25 may be applied to the second link arm 12 not provided with the coupling length variable mechanism 35.

Next, technical ideas that can be understood from each of the embodiments and modifications described above will be described.

(A) The coupling length variable mechanism is an extensible link mechanism of linearly moving type including a door-side link having the first pivot coupling point and a vehicle-body-side link having the second pivot coupling point, and the door-side link and the vehicle-body-side link are disposed relatively displaceable along an axial direction.

According to the configuration described above, a coupling length between the first and second pivot coupling points can be changed on the basis of relative displacement between the vehicle-body-side link and the door-side link.

(B) The cam member is provided integrally with a door bracket fixed to the door and forming the second pivot coupling point. Thus, the configuration can be simplified and space saving can be achieved.

(C) The vehicle door apparatus includes a stopper mechanism having first and second abutting portions that come into contact with and separate from each other on the basis of operation of the coupling length variable mechanism, and an opening and closing motion track of the door shifts from the linear-shaped track to the arc-shaped track by the first and second abutting portions abutting on each other thereby restricting a change in the coupling length.

According to the configuration described above, the coupling length between the first and second pivot coupling points is stably maintained. Thus, a stable opening and closing motions of the door can be achieved.

(D) The coupling length variable mechanism is a joint link mechanism including a vehicle-body-side link having the first pivot coupling point and a door-side link having the second pivot coupling point, the vehicle-body-side link and the door-side link are pivotably coupled to each other, one of the first and second abutting portions is provided on the door-side link, another one of the first and second abutting portions is provided on a door bracket fixed to the door, and the door bracket constitutes the second pivot coupling point by the door-side link being pivotably coupled to the door bracket.

In a configuration in which the joint link mechanism is used as the coupling length variable mechanism, the coupling length between the first and second pivot coupling points is a constant value based on a length of the vehicle-body-side link when the door-side link is integrated with the door. According to the configuration described above, the coupling length between the first and second pivot coupling points can be stably maintained on the basis of a function of the stopper mechanism.

(E) The cam groove includes an arc-shaped portion corresponding to the arc-shaped track, a linear portion corresponding to the linear-shaped track, and a curved connection portion connecting the arc-shaped portion and the linear portion.

According to the configuration described above, it is possible to define a stable arc-shaped track and linear-shaped track of the door.

1. A vehicle door apparatus comprising:
first and second link arms each having a first pivot coupling point with respect to a vehicle body and a second pivot coupling point with respect to a door of a vehicle; and
a coupling length variable mechanism provided on at least one of the first and second link arms and is configured such that a coupling length serving as a distance between the first and second pivot coupling points is variable,
wherein
the first and second link arms form a link mechanism configured to cause the door to perform opening and closing motions along a specified opening and closing motion track, and
the coupling length variable mechanism is configured to operate to change the opening and closing motion track between an arc-shaped track and a linear-shaped track.

2. The vehicle door apparatus according to claim 1, wherein the coupling length variable mechanism is a joint link mechanism including a vehicle-body-side link having the first pivot coupling point, and a door-side link having the second pivot coupling point, and
the vehicle-body-side link and the door-side link are pivotably coupled to each other.

3. The vehicle door apparatus according to claim 2, wherein the door-side link includes a pair of holding portions pivotably coupled to the vehicle-body-side link while sandwiching the vehicle-body-side link, and pivotably coupled to the door at positions separated from each other in an up-down direction.

4. The vehicle door apparatus according to claim 2, further comprising a biasing member that generates a biasing force that causes the vehicle-body-side link and the door-side link to relatively pivot.

5. The vehicle door apparatus according to claim 4, wherein the joint link mechanism is configured such that, when the door performs an opening motion from a fully closed position, a component force of the biasing force in a direction along the coupling length is stronger than the component force at a fully closed position, on the basis of relative pivoting of the vehicle-body-side link and the door-side link.

6. The vehicle door apparatus according to claim 1, further comprising:
an engagement protrusion provided on at least one of the first and second link arms so as to be combined with the coupling length variable mechanism; and
a cam member having a cam groove with which the engagement protrusion is engaged, and provided on the door or the vehicle body,
wherein
the opening and closing motion track of the door is defined by the engagement protrusion moving in the cam groove on the basis of opening and closing motions of the door.

7. The vehicle door apparatus according to claim 6, wherein the cam groove is configured to define the coupling length on the basis of a position of the engagement protrusion in the cam groove.

8. The vehicle door apparatus according to claim 6, further comprising a stopper mechanism having first and second abutting portions that come into contact with and separate from each other on the basis of a motion of the coupling length variable mechanism,
wherein
the first and second abutting portions are configured to restrict a change in the coupling length by abutting on each other, by which the opening and closing motion track of the door shifts from the linear-shaped track to the arc-shaped track,
the cam groove includes
an arc-shaped portion corresponding to the arc-shaped track,
a linear portion corresponding to the linear-shaped track, and
a curved connection portion connecting the arc-shaped portion and the linear portion, and
when the engagement protrusion in the cam groove moves from the linear portion to the arc-shaped portion, movement of the engagement protrusion is guided by the engagement protrusion coming into sliding contact with the curved connection portion.

9. The vehicle door apparatus according to claim 1, further comprising a buffer member sandwiched between at least one of the first and second link arms and the vehicle body in a case where the door is at a fully open position.

10. The vehicle door apparatus according to claim 1, wherein at least one of the first and second pivot coupling points in the first and second link arms includes
a plate-shaped coupling portion,
a through hole penetrating the plate-shaped coupling portion in a thickness direction,
a cylindrical buffer member fitted into the through hole, and
a support shaft inserted into the cylindrical buffer member.

11. The vehicle door apparatus according to claim 1, wherein
at least one of the first and second pivot coupling points in the first and second link arms includes first and second pivot coupling portions relatively pivotably coupled to each other, and
the vehicle door apparatus includes a friction member interposed between the first and second pivot coupling portions, and the friction member applies sliding resistance to the first and second pivot coupling portions by coming into sliding contact with the first and second pivot coupling portions.

12. The vehicle door apparatus according to claim 1,
wherein
the door has a closing-side end portion,
a door opening portion of the vehicle, the door opening portion being opened and closed by the door, has a closing-side end portion that the closing-side end portion of the door comes into contact with and separates from on the basis of opening and closing motions of the door,
the vehicle door apparatus includes
a door-side engagement portion provided on the closing-side end portion of the door, and
a vehicle-body-side engagement portion provided on the closing-side end portion of the door opening portion,
one of the door-side engagement portion and the vehicle-body-side engagement portion includes a shaft-shaped engagement portion extending in an up-down direction of the vehicle,
another one of the door-side engagement portion and the vehicle-body-side engagement portion includes a guide groove having a pair of side wall portions facing each other in a vehicle width direction and extending in opening and closing motion directions of the door, and
the door-side engagement portion and the vehicle-body-side engagement portion are configured so as to be engaged with each other in a state where the shaft-shaped engagement portion is disposed in the guide groove, when the door is positioned in a vicinity of the fully closed position.

13. The vehicle door apparatus according to claim 1, further comprising an actuator that drives the link mechanism to cause the door to perform opening and closing motions.

14. The vehicle door apparatus according to claim 13, wherein
the coupling length variable mechanism is provided on one of the first and second link arms, and
the actuator is configured to apply a drive force to another one of the first and second link arms not provided with the coupling length variable mechanism.

15. The vehicle door apparatus according to claim 1, further comprising a coupling length fixing mechanism configured to enable fixing of the coupling length.

16. The vehicle door apparatus according to claim 15,
wherein
the coupling length variable mechanism is a joint link mechanism including a vehicle-body-side link having the first pivot coupling point and a door-side link having the second pivot coupling point,
the vehicle-body-side link and the door-side link are pivotably coupled to each other,
the coupling length fixing mechanism includes
a first engagement member provided on the door-side link, and
a second engagement member provided on the door,
the first engagement member and the second engagement member are configured so as to be engaged with and disengaged from each other on the basis of opening and closing motions of the door, and
the coupling length fixing mechanism is configured to
fix the coupling length by fixing the door-side link to the door and restricting a relative pivoting of the door-side link with respect to the door, when the first engagement member and the second engagement member are engaged with each other, and
release fixing of the coupling length when the first engagement member and the second engagement member are disengaged from each other.

17. The vehicle door apparatus according to claim 16,
wherein the coupling length fixing mechanism includes
a timing generation unit configured to generate engagement and disengagement timings of the first engagement member and the second engagement member on the basis of opening and closing motions of the door, and
an engagement and disengagement drive unit configured to cause the first engagement member and the second engagement member to be engaged with and disengaged from each other on the basis of generated the engagement and disengagement timings.

18. The vehicle door apparatus according to claim 17,
wherein
the first engagement member is an engagement protrusion provided on the door-side link,
the second engagement member is a hook lever engaged with and disengaged from the engagement protrusion by pivoting about a support shaft provided on the door,
the coupling length fixing mechanism includes
a pressing protrusion provided on the vehicle-body-side link, and
a hook cam provided on the hook lever,
the hook cam and the pressing protrusion are relatively displaced by the vehicle-body-side link pivoting on the basis of opening and closing motions of the door, by which the hook cam and the pressing protrusion are engaged with and disengaged from each other, and
the timing generation unit and the engagement and disengagement drive unit are configured such that the hook lever pivots by the hook cam and the pressing protrusion being engaged with and disengaged from each other.

19. The vehicle door apparatus according to claim 17,
wherein
the first engagement member is an engagement protrusion provided on the door-side link,
the second engagement member is a hook lever engaged with and disengaged from the engagement protrusion by pivoting about a support shaft provided on the door,
the door has a closing-side end portion,
a door opening portion of the vehicle, the door opening portion being opened and closed by the door, has a closing-side end portion that the closing-side end portion of the door comes into contact with and separates from on the basis of opening and closing motions of the door,
the coupling length fixing mechanism includes
a door lever provided on the closing-side end portion of the door,
a vehicle-body cam provided on the closing-side end portion of the door opening portion, and
a connection member connecting the door lever and the hook lever,
the timing generation unit is formed by the door lever and the vehicle-body cam being engaged with and disengaged from each other on the basis of opening and closing motions of the door, and
the engagement and disengagement drive unit is formed by operation of the door lever being transmitted to the hook lever via the connection member.

20. The vehicle door apparatus according to claim 15,
wherein
the door has a closing-side end portion,
a door opening portion of the vehicle, the door opening portion being opened and closed by the door, has a closing-side end portion that the closing-side end portion of the door comes into contact with and separates from on the basis of opening and closing motions of the door,
the vehicle door apparatus includes
a door-side engagement portion provided on the closing-side end portion of the door, and
a vehicle-body-side engagement portion provided on the closing-side end portion of the door opening portion,
one of the door-side engagement portion and the vehicle-body-side engagement portion includes a guide engagement portion,
another one of the door-side engagement portion and the vehicle-body-side engagement portion includes a guide groove having a pair of side wall portions facing each other and extending in opening and closing motion directions of the door,
the door-side engagement portion and the vehicle-body-side engagement portion are configured so as to guide opening and closing motions of the door in a state where the guide engagement portion is disposed in the guide groove, when the door is positioned in a vicinity of the fully closed position, and
the coupling length fixing mechanism is configured so as to
fix the coupling length at a timing when engagement between the door-side engagement portion and the vehicle-body-side engagement portion are released, on the basis of an opening motion of the door moved from the fully closed position, and
release fixing of the coupling length at a timing when the door-side engagement portion and the vehicle-body-side engagement portion are engaged with each other, on the basis of a closing motion of the door moving to the fully closed position.
